(19) United States
(12) Patent Application Publication
(10) Pub. No.: US 2015/0019247 A1
(43) Pub. Date: Jan. 15, 2015

(54) Doctor-Selection-Facilitating Method

(71) Applicant: Anthony Joseph Stedillie, Beachwood, OH (US)

(72) Inventor: Anthony Joseph Stedillie, Beachwood, OH (US)

(73) Assignee: NAVIGO HEALTH INC., Beachwood, OH (US)

(21) Appl. No.: 14/329,895

(22) Filed: Jul. 12, 2014

Related U.S. Application Data
(60) Provisional application No. 61/846,497, filed on Jul. 15, 2013.

(51) Int. Cl. G06Q 30/06; G06Q 50/22

(52) U.S. Cl. CPC G06Q 30/0629; G06Q 50/22
USPC 705/2

(57) ABSTRACT

A doctor-selection-facilitating system (10) comprises a step (20) of attaining a roster of doctor dossiers, a step (30) of obtaining a patient portfolio, and a step (40) of ranking the doctor dossiers. The roster-ranking step (40) involves ascertaining the personality attributes the patient regards as important in a doctor, and then determining which doctors which are predisposed to these traits. The ranking results can be reported to the relevant healthcare organization and/or insurance carrier, via a private virtual network.

### RELATED APPLICATION

This application claims priority under 35 USC §119(e) to U.S. Provisional Patent Application No. 61/846,497 filed on Jul. 15, 2013. The entire disclosure of this provisional patent application is hereby incorporated by reference. To the extent that any inconsistencies exist between the provisional patent application and the present disclosure, the latter governs for the purposes of resolving clarity and/or indefiniteness issues.

### BACKGROUND

The selection of a doctor can be daunting task for a patient, especially when this task is induced by injury or illness. While resumes, referrals, and other relevant records are helpful, they alone are often not enough to insure a productive patient-doctor relationship.

### SUMMARY

A computerized system is provided to facilitate the selection of a doctor for a particular patient. The system involves ascertaining which personality traits the patient regards as important in a doctor, and then finding doctors predisposed to such personality traits. When a doctor is selected in this manner, he or she will consequentially have a personality complementary to that of the patient. This doctor-patient personality pairing greatly improves the patient's likelihood to successfully (and effortlessly) interact with the selected doctor. And it allows the doctor to concentrate on medical matters, rather than expending energy on attempting to adapt to the patient's personality.

### DRAWINGS

FIGS. 1A-1F each show a system 10 for facilitating doctor selection, and FIGS. 1G-1K each show a computer-populated system in which steps of these systems are performed.

FIGS. 2A-2Y, FIGS. 3A-3X, FIGS. 4A-4N, FIGS. 5A-5N, FIGS. 6A-6N, and FIGS. 7A-7C show details of a roster-attaining step 20, a portfolio-obtaining step 30, a roster-ranking step 40, a rank-reporting step 50, a roster-revising step 60, and a portfolio-updating step 70, respectively.

### DESCRIPTION

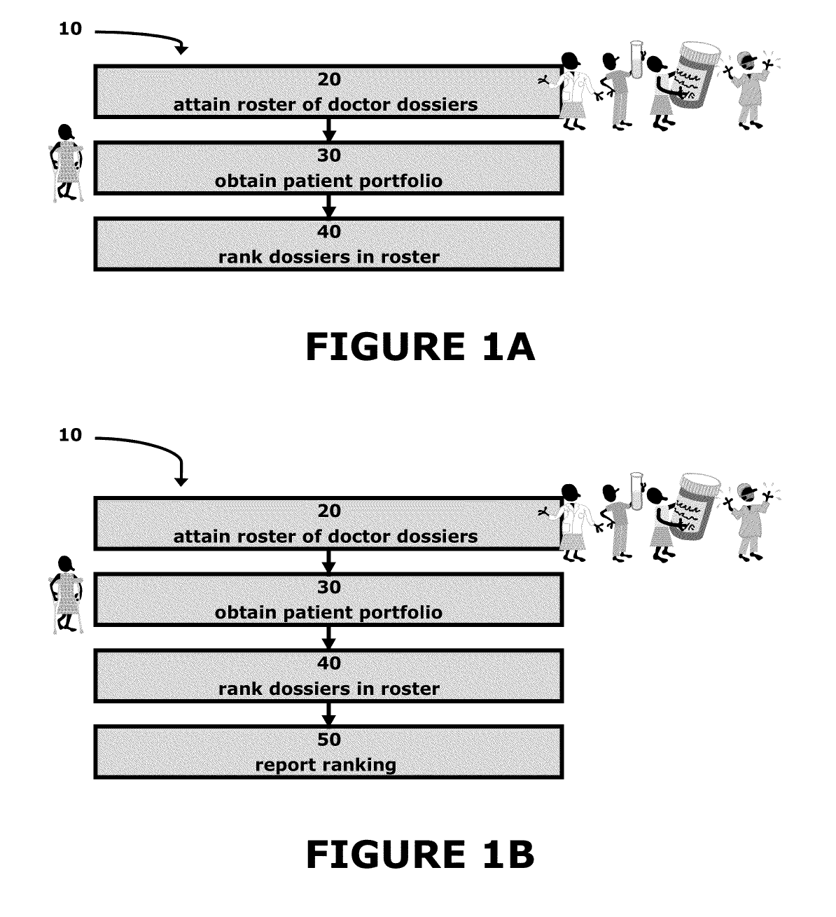

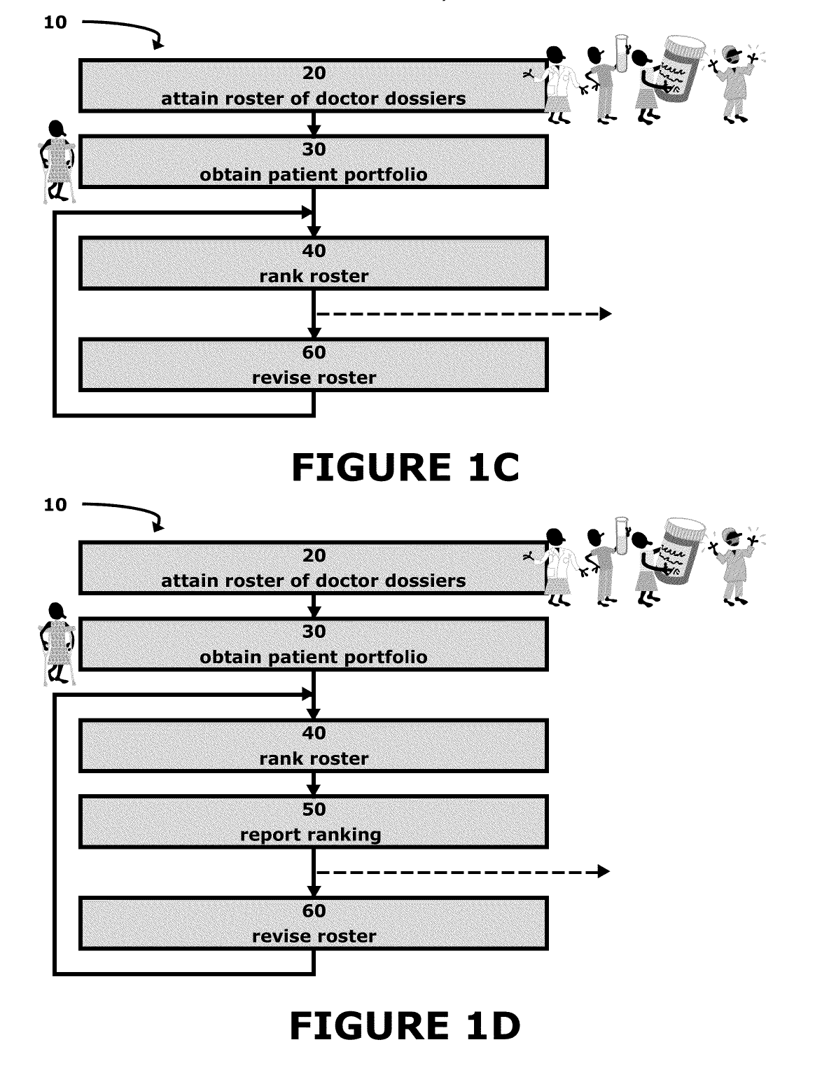

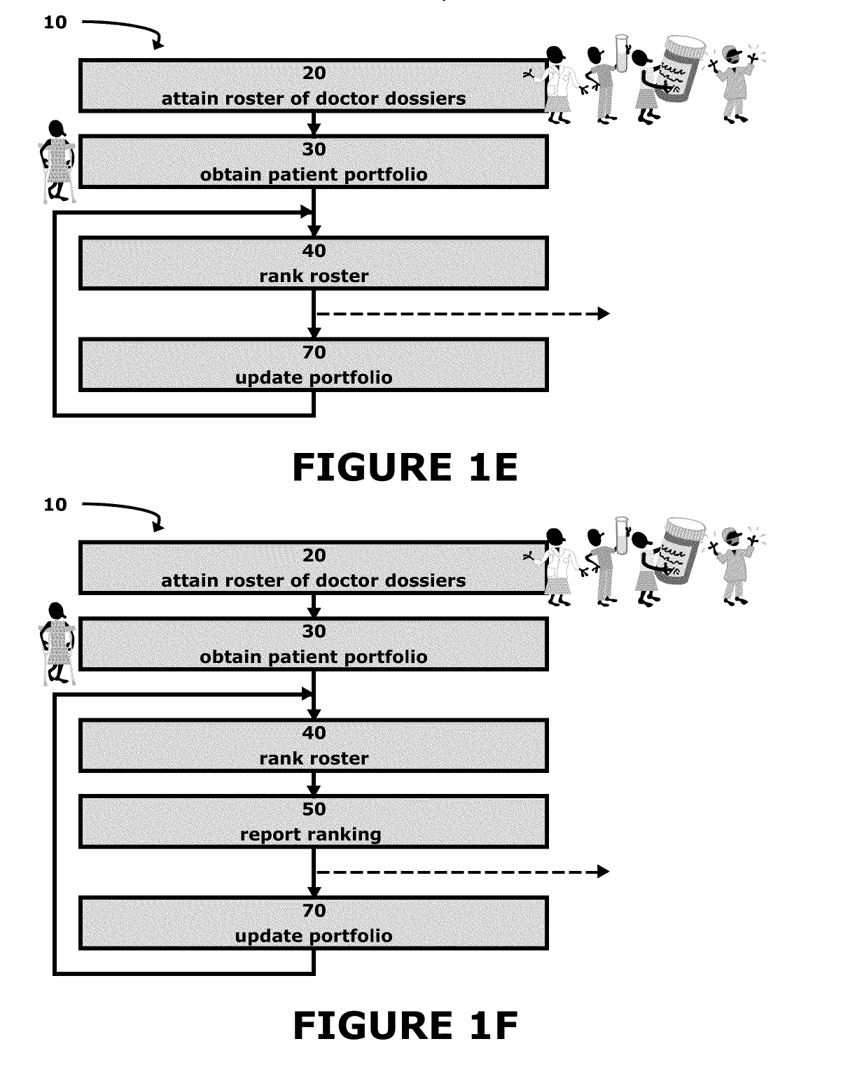

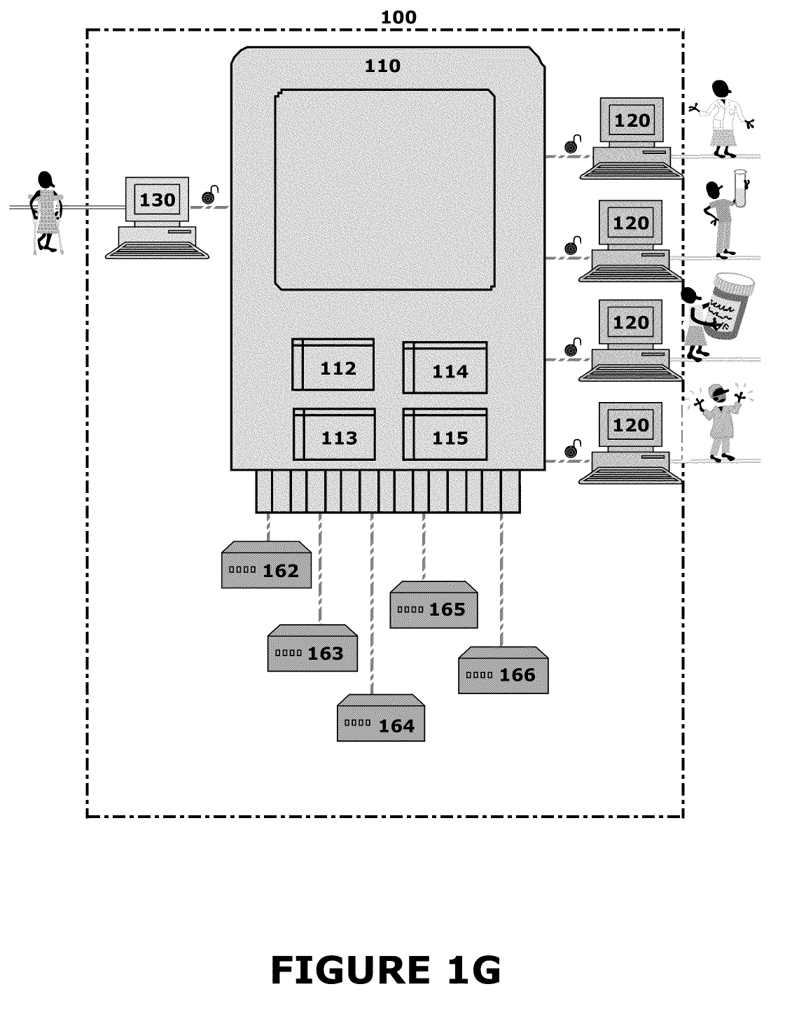

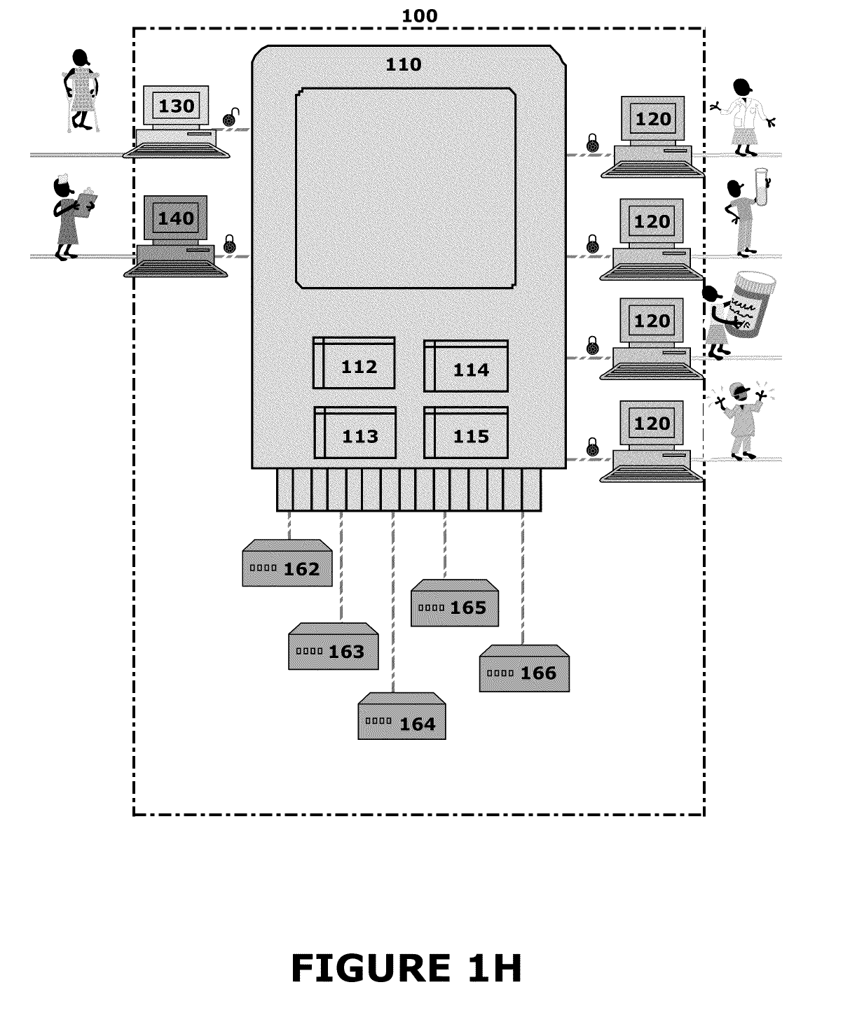

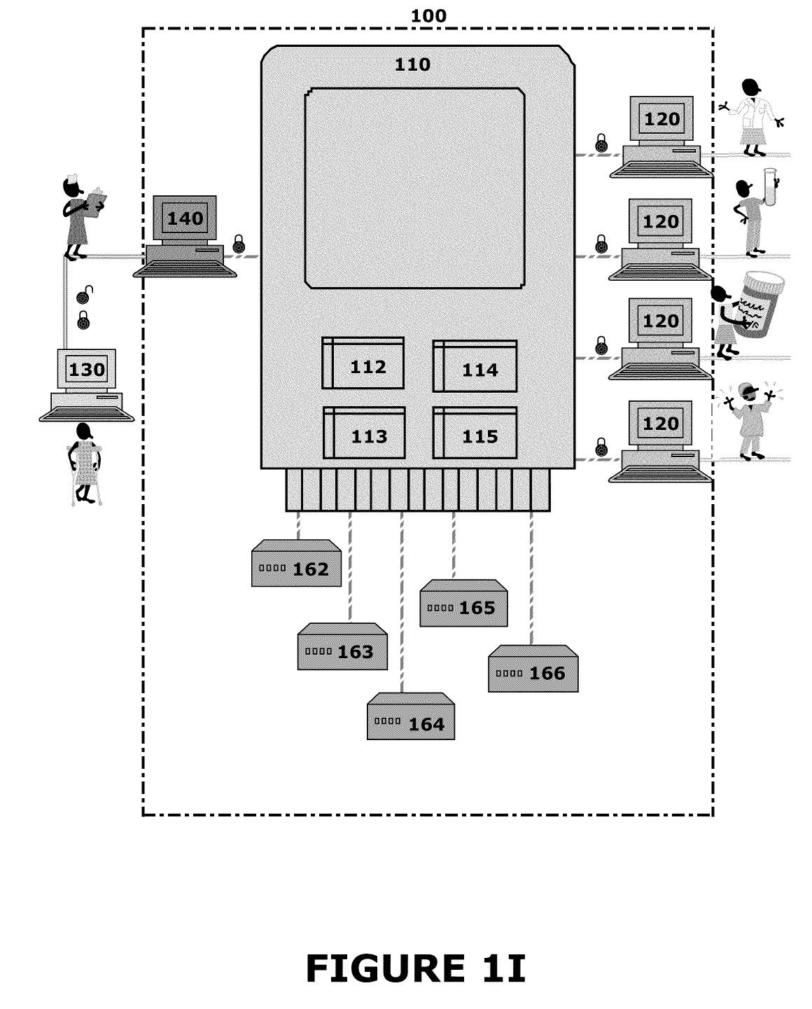

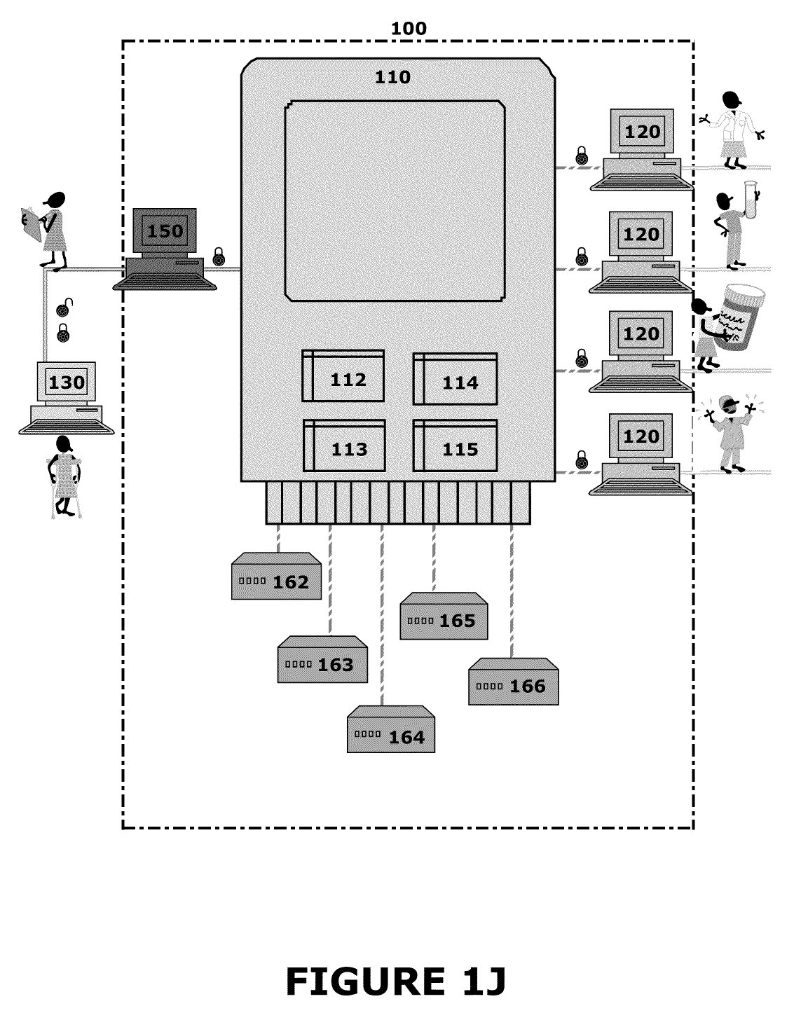

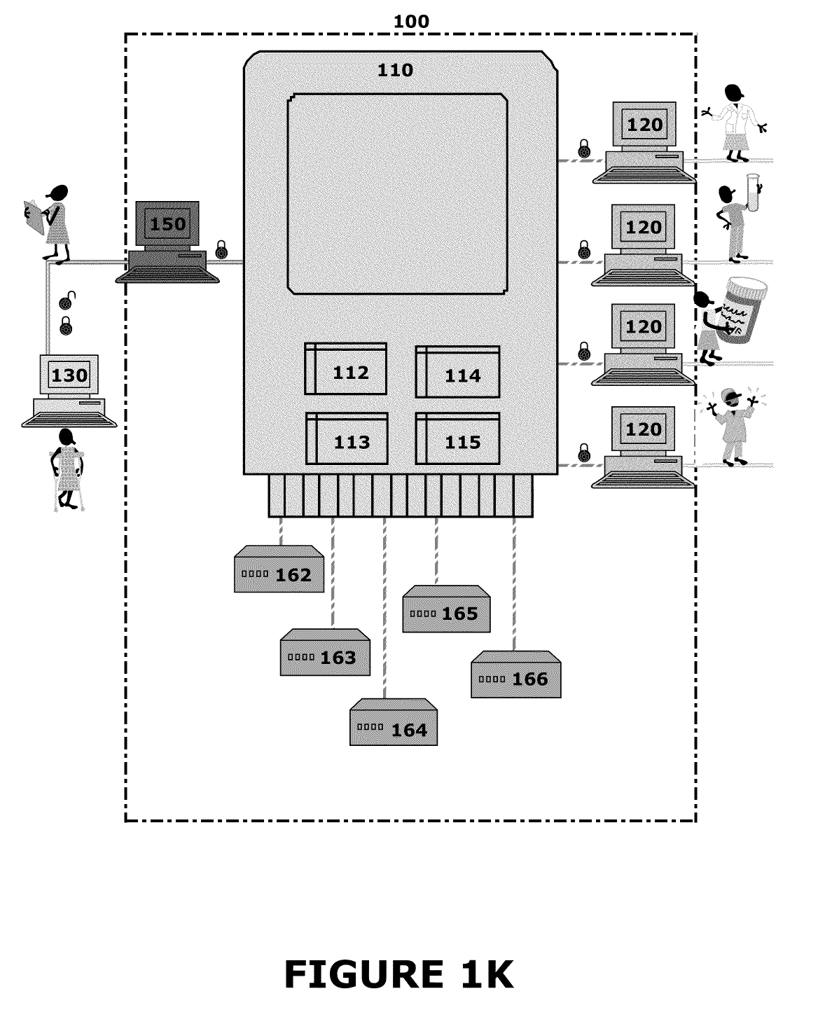

Referring now to the drawings, and initially to FIGS. 1A-1G, a doctor-selection-facilitating system 10 is shown. The system 10 includes a step 20 of attaining a roster of doctor dossiers, a step 30 of obtaining a patient portfolio, and a step 40 of ranking the roster relative to the patient portfolio. (FIG. 1A.) The system 10 can also include a step 50 of reporting the results of the ranking step 40, a step 60 of revising the roster, and/or a step 70 of updating the portfolio. (FIGS. 1B-1F.)

The doctor-selection-facilitating system 10 is performed within a computer-populated colony 100. The colony 100 can comprise a public network, such as the Internet. Additionally or alternatively, the computer-populated colony 100 can comprise a VPN (virtual private network) incorporating dedicated connections, virtual tunneling protocols, and/or traffic encryptions. (FIGS. 1G-1K.)

The computer-populated colony 100 can comprise a server 110 which is a powerful computing device capable of managing network resources, lodging storage sites, responding to external commands, and/or communicating with outside computers. The server 110 can coordinate the congregation of data for the roster-attaining step 20, the portfolio-obtaining step 30, the roster-revising step 60, and/or the portfolio-updating step 70. The server 110 can also effectuate the execution of the ranking step 40.

The server 110 can have internal storage sites 112-115 for storing data accumulated during performance of the system 10. These sites can comprise hard disk drives, RAM memory, or any other suitable readable data storage systems. The numbering of the storage sites 112-115 is done solely for ease in explanation, as they can be configured in any apposite arrangement. For example, some or all of the storage sites can be combined and/or a single illustrated site can actually comprise plural sites. Additionally or alternatively, one or more of the internal storage sites 112-115 could instead be an external storage site networked to the server 110.

The computer-populated colony 100 also includes doctor computers 120, a patient computer 130, a healthcare organization computer 140, and/or an insurance-carrier computer 150. The computers can be desktop, server, portable, hand-held, set-top box, personal digital assistant, a terminal, or any other desired type or configuration which can be networked with the server 110. Some or all of the doctor computers 120 may, but need not be, networked to directly communicate with each other. And if the computer-populated colony 100 includes a patient computer 130 it may be networked to not directly communicate with the doctor computers 120.

The computer-populated system 100 can further comprise servers 162-166 which are remote from the server 110 but networkable thereto. The numbering of these servers is again done solely for ease in explanation, as combined servers and/or multiple servers are feasible and foreseeable. And one, some or all of the servers 162-165 could be replaced with databases internal to the server 110.

The doctor computers 120 can interface with the server 110 via a public network and the patient computer 130 can interface with the server 110 via a public network. For example, an IP address can be used to route data to a website on the server 110. The doctor computers 120 can convey data to the server 110 during the roster-attaining step 20 and the patient computer 130 can convey data to the server 110 during the portfolio-obtaining step 30. The ranking results could be reported to the patient computer 130 during step 50. (FIG. 1G.)

The doctor computers 120 can interface with the server 110 via a private network, the patient computer 130 can interface with the server 110 via a public network, and the healthcare organization computer 130 can interface with the server 110 via a private network. The doctor computers 120 can convey data to the server 110 during the roster-attaining step 20, and the patient computer 130 can convey data to the server 110 during the portfolio-obtaining step 30. During the rank-reporting step 50, the server 110 could report results healthcare organization computer 140 via a private network. (FIG. 1H.)

The doctor computers 120 can interface with the server 110 via a private network. The patient computer 120 can be outside the perimeter of the computer-populated colony 100 and convey data to the healthcare organization and/or its computer 140 via a public network or a private network. The healthcare organization computer 140 could then convey patient information to the server 110 via a private network to accomplish the portfolio-obtaining step 30. The ranking results could be reported, via a private network, to the healthcare organization computer 140 during step 50. (FIG. 1I.)

The doctor computers 120 can interface with the server 110 via a private network to complete the dossier-attaining step 20. The patient computer 130 can interface with the server 110 via a public network, and the healthcare organization computer 140 can interface with the server 110 via a private network. The patient computer 130 can convey data to the server 110 during the portfolio-obtaining step 30. During the rank-reporting step 50, the server 110 could report results healthcare organization computer 140 via a private network. (FIG. 1H.)

The doctor computers 120 can interface with the server 110 via a private network to complete the dossier-attaining step 120. The patient computer 120 can be outside the computer-populated colony 100 and convey data to the healthcare organization and/or its computer 140 via a public network or a private network. The healthcare organization computer 140 could then convey patient information to the server 110 via a private network to accomplish the portfolio-obtaining step 30. The ranking results could be reported, via a private network, to the healthcare organization computer 140 during step 50. (FIG. 1I.)

The doctor computers 120 can interface with the server 110 via a private network to complete the dossier-attaining step 20. The patient computer 130 can interface with the server 110 via a public network, and the insurance carrier computer 150 can interface with the server 110 via a private network. The patient computer 130 can convey data to the server 110 during the portfolio-obtaining step 30. During step 50, the server 110 could report results to insurance carrier computer 150 via a private network. (FIG. 1J.)

The doctor computers 120 can interface with the server 110 via a private network to complete the dossier-attaining step 120. The patient computer 120 can be outside the computer-populated colony 100 and convey data to the insurance carrier and/or its computer 150 via a public network or a private network. The insurance carrier computer 150 could then convey patient information to the server 110 via a private network to accomplish the portfolio-obtaining step 30. The ranking results could be reported, via a private network, to the insurance carrier computer 150 during step 50. (FIG. 1K.)

### Roster-Attaining Step 20

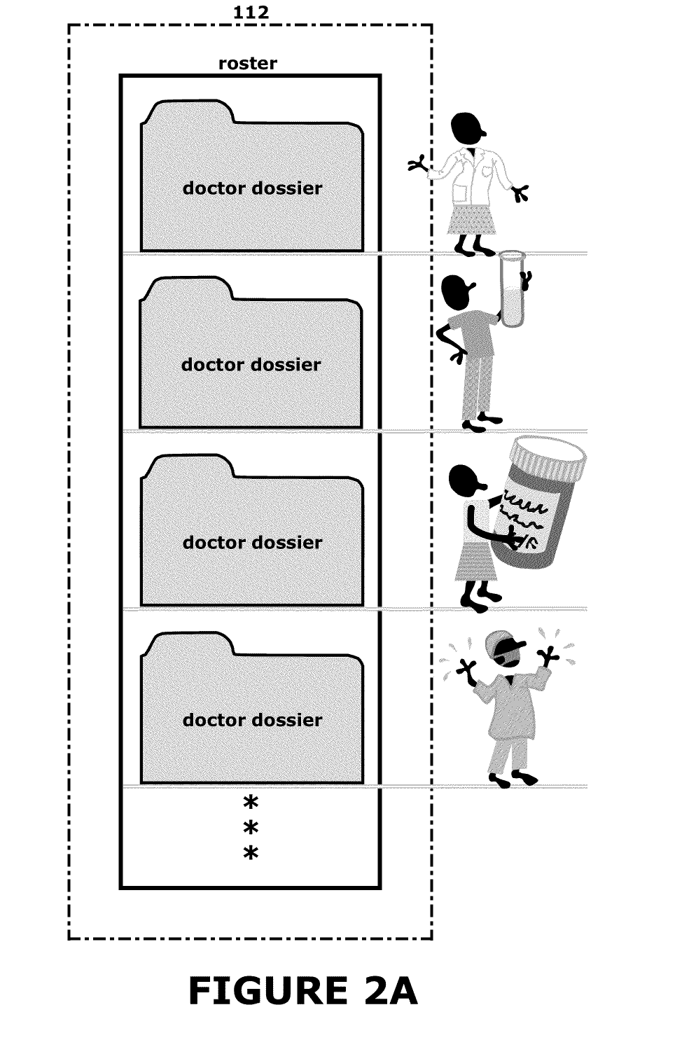

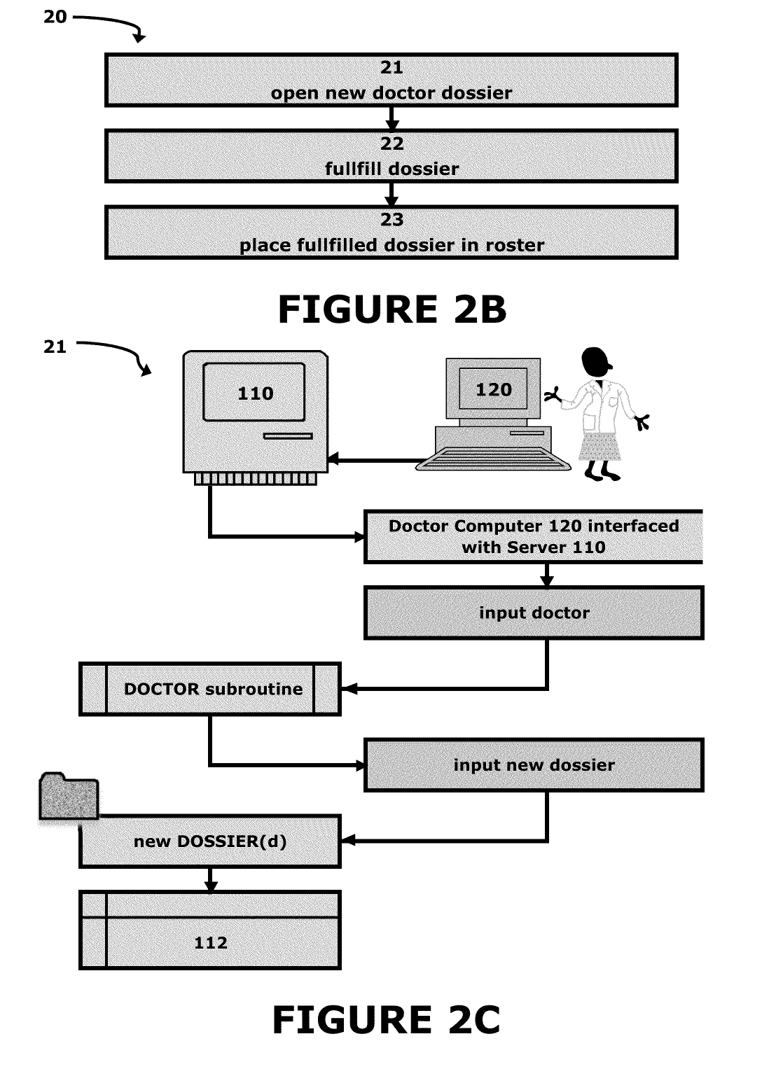

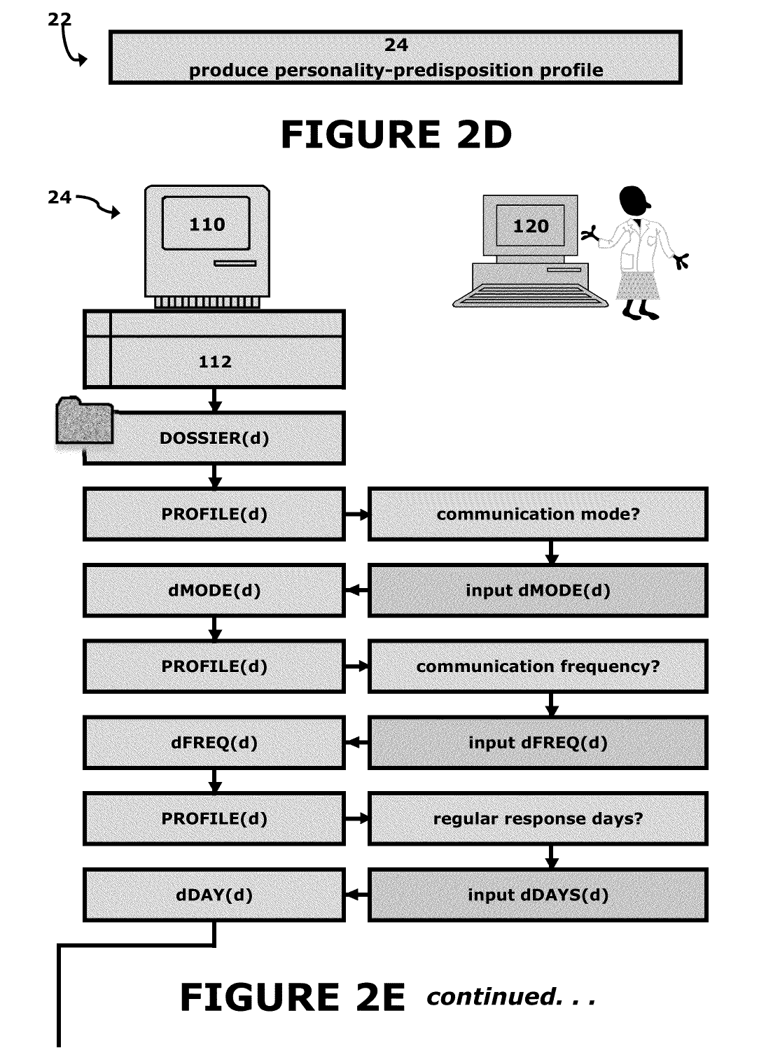

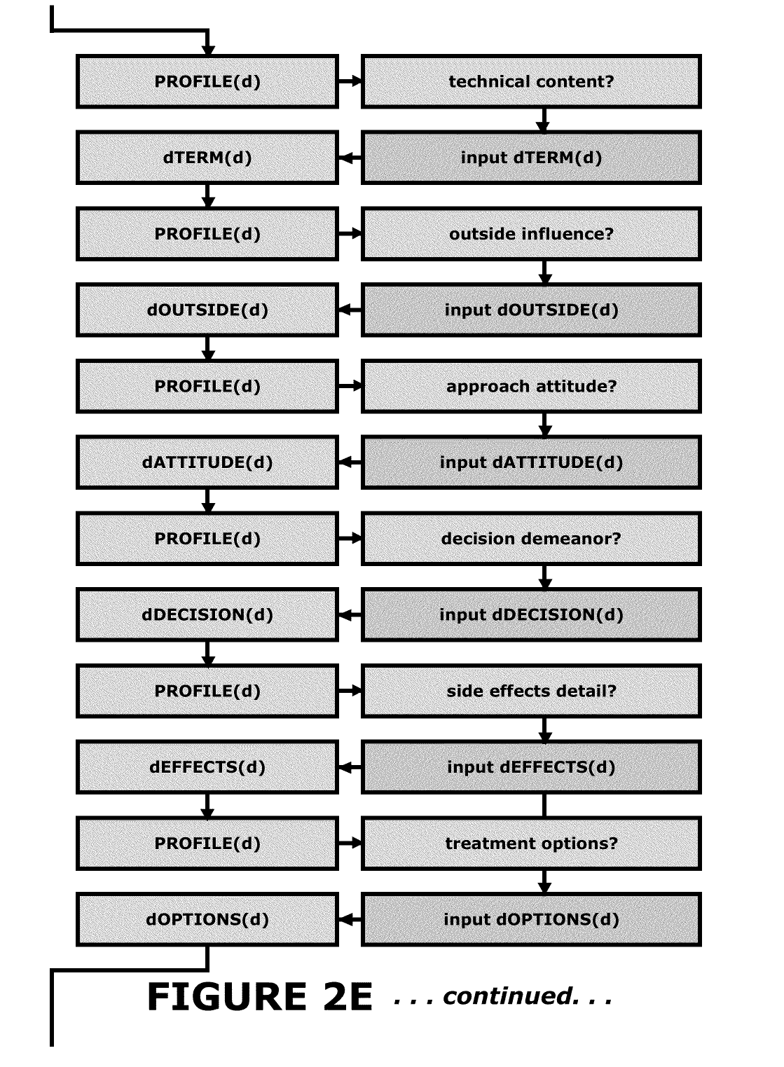

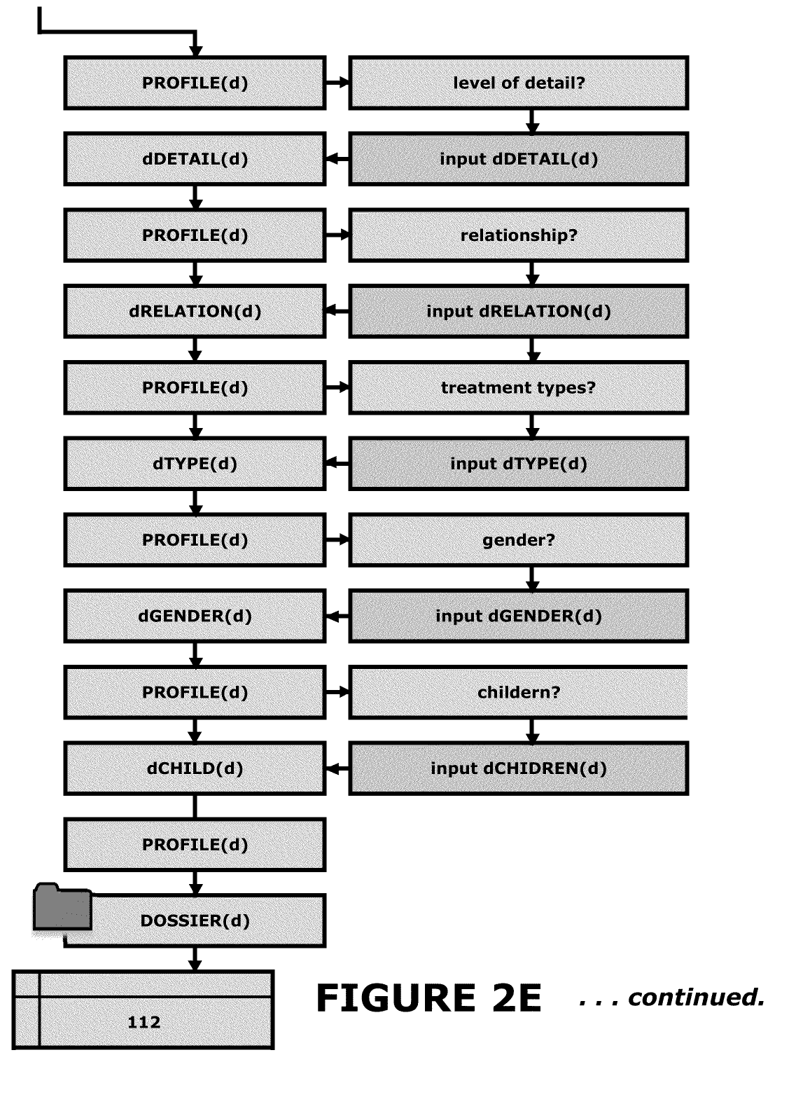

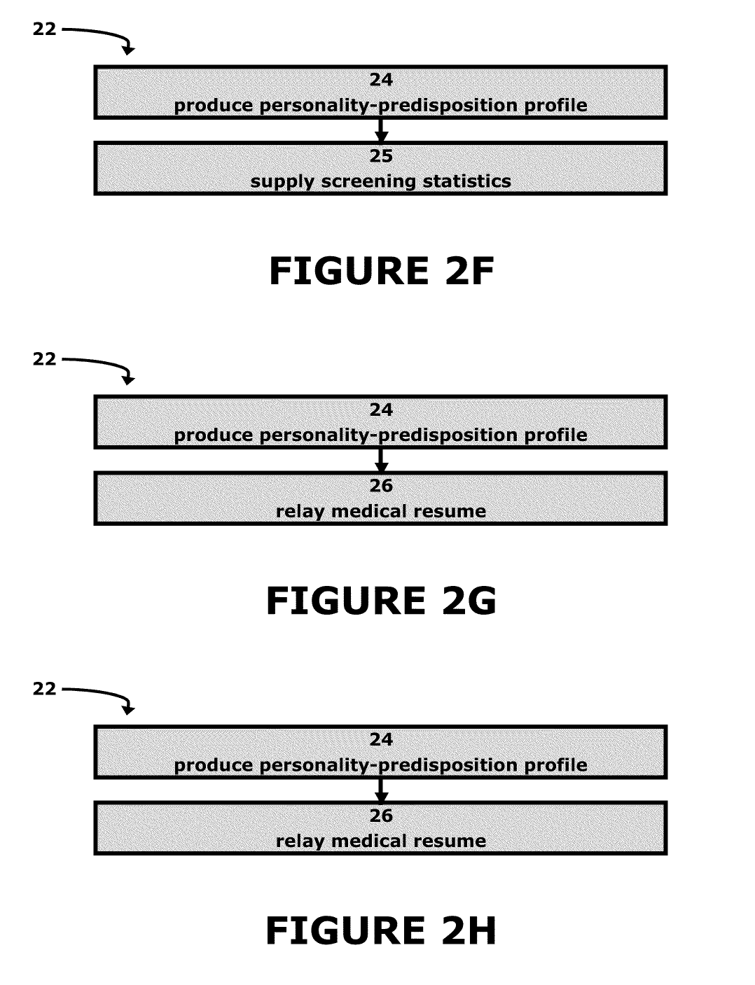

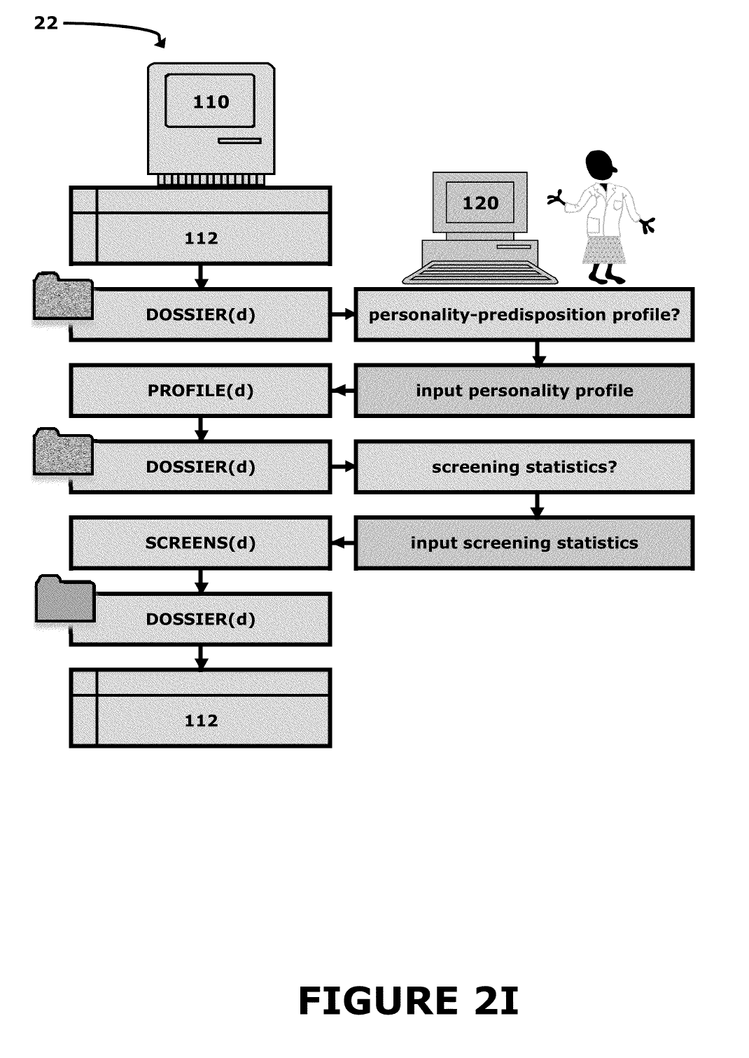

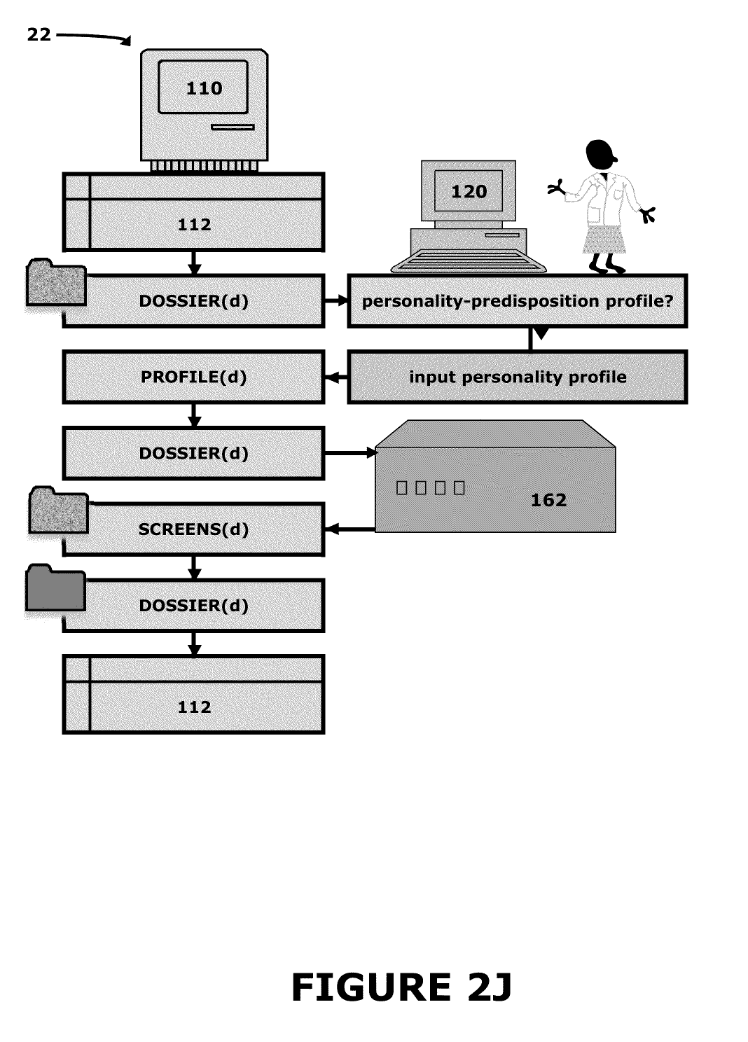

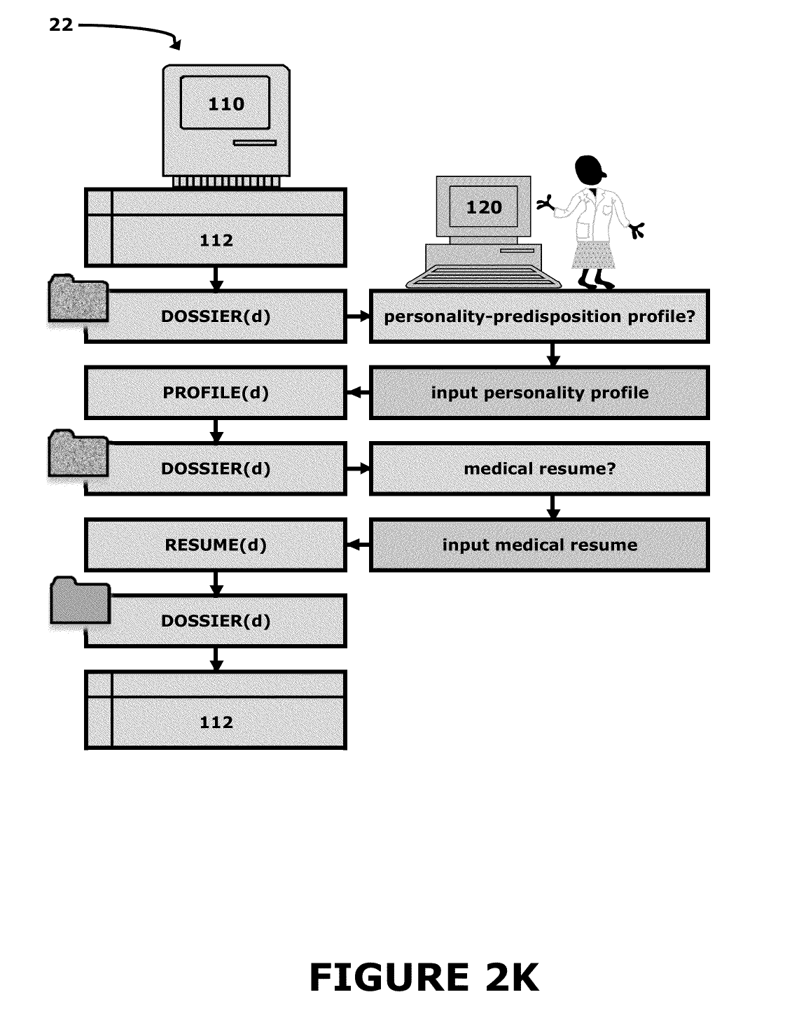

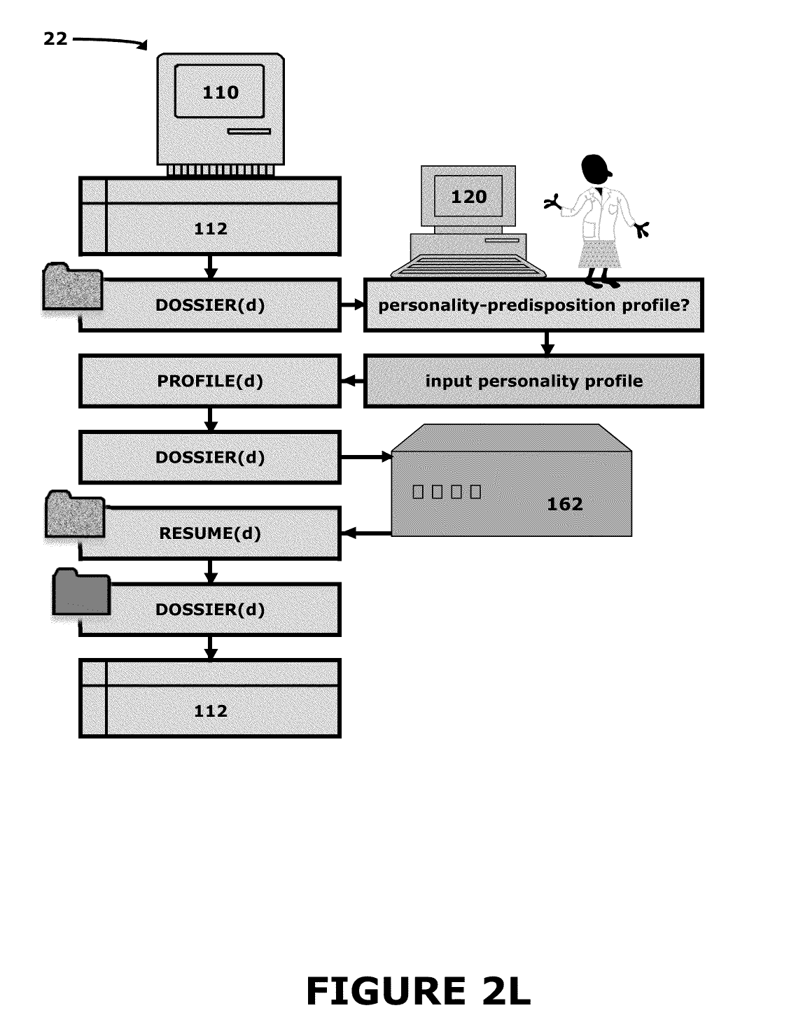

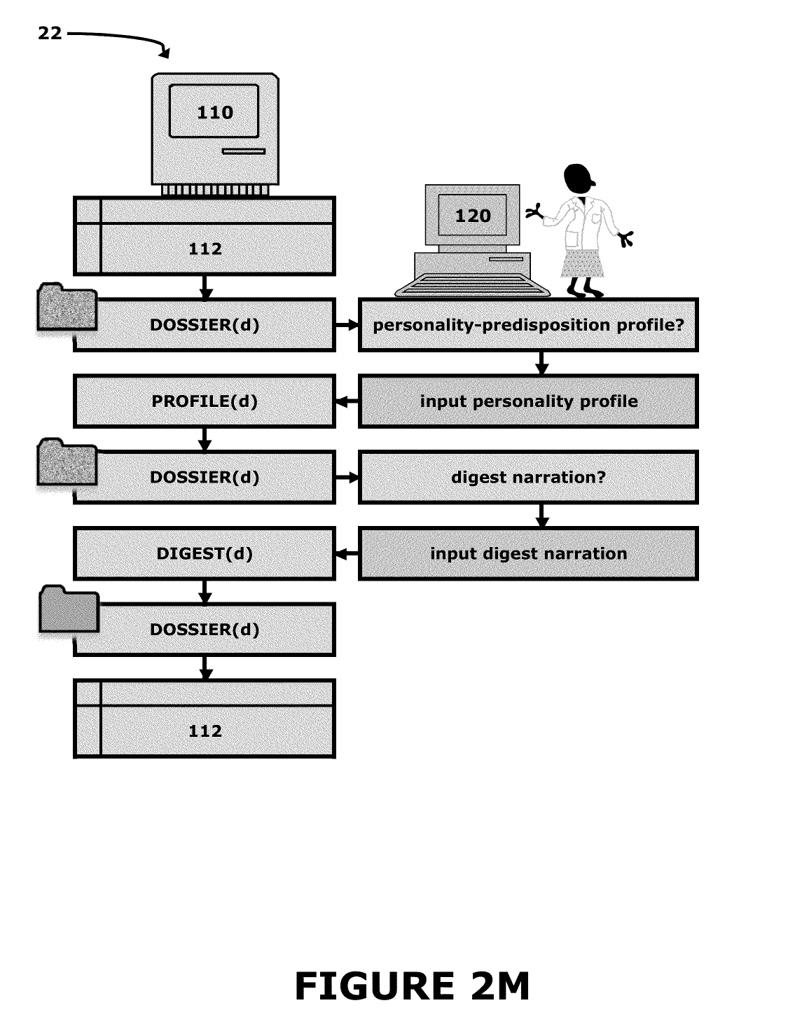

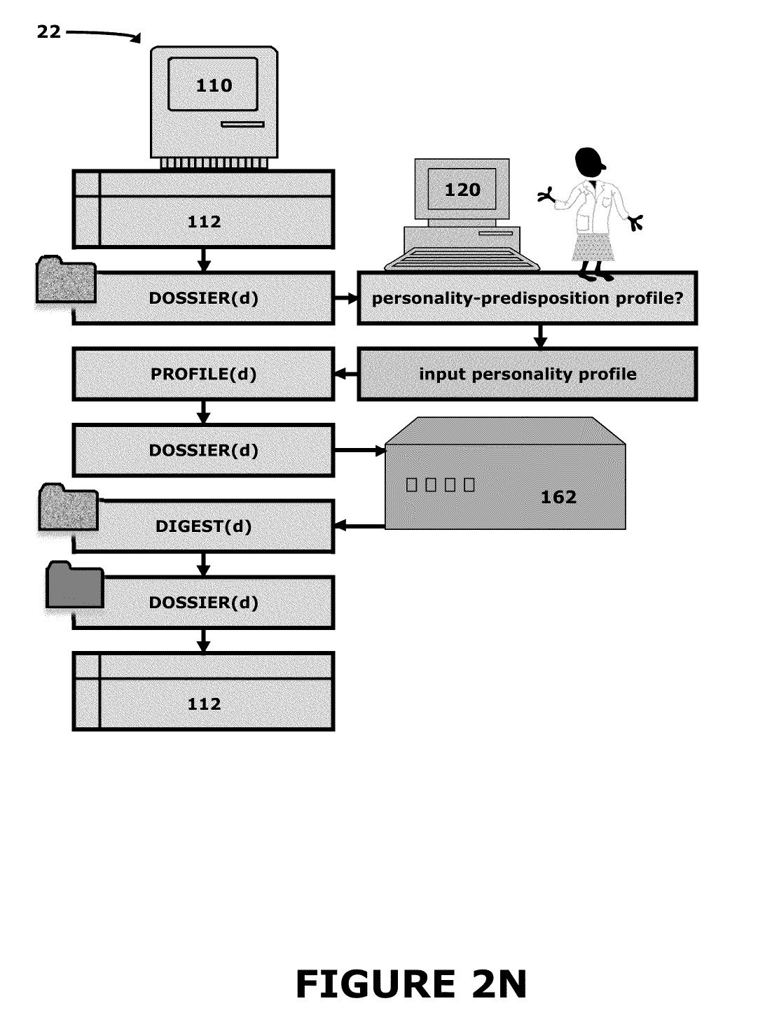

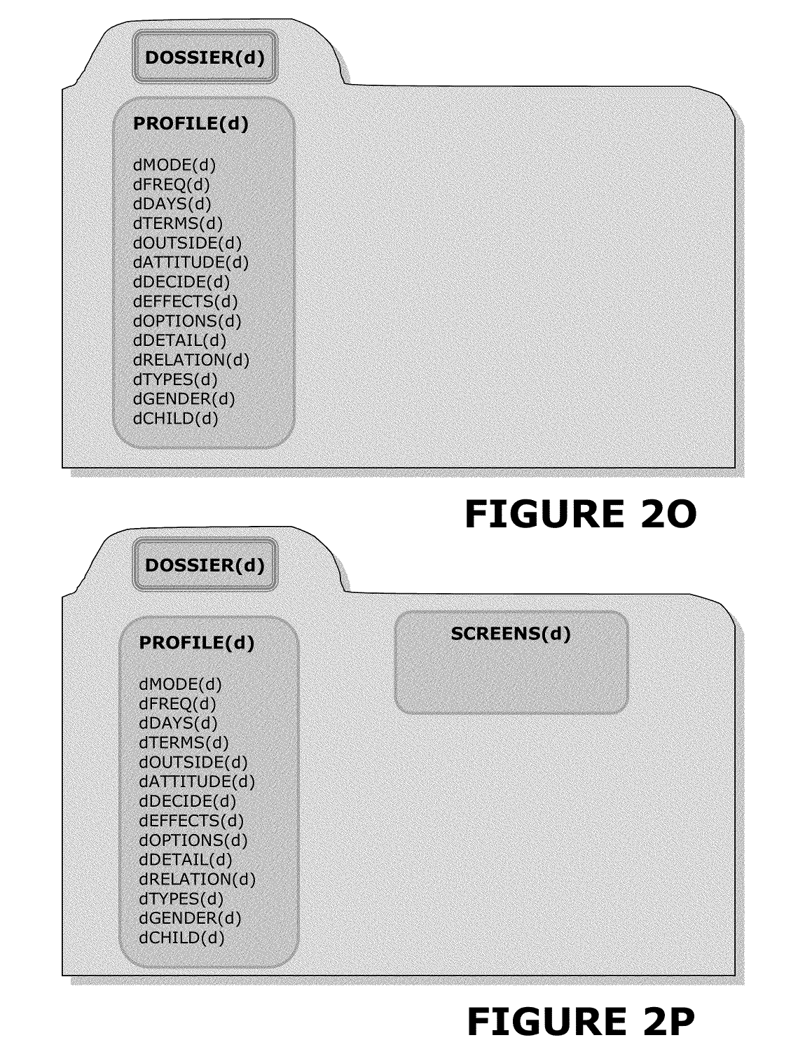

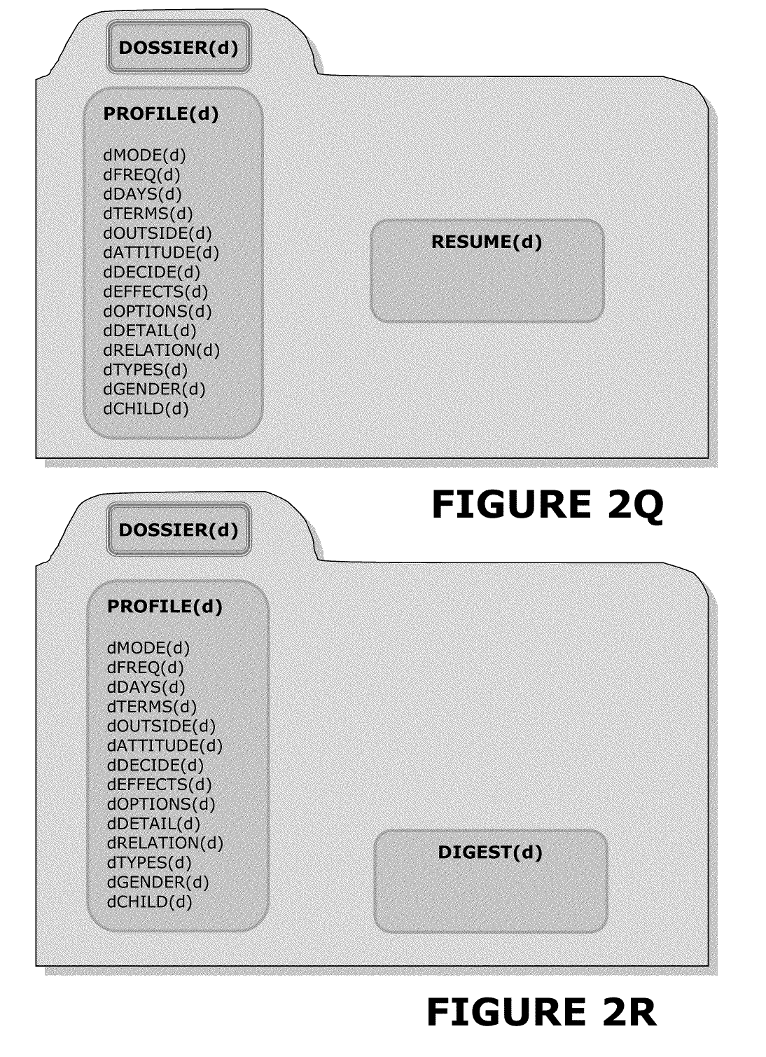

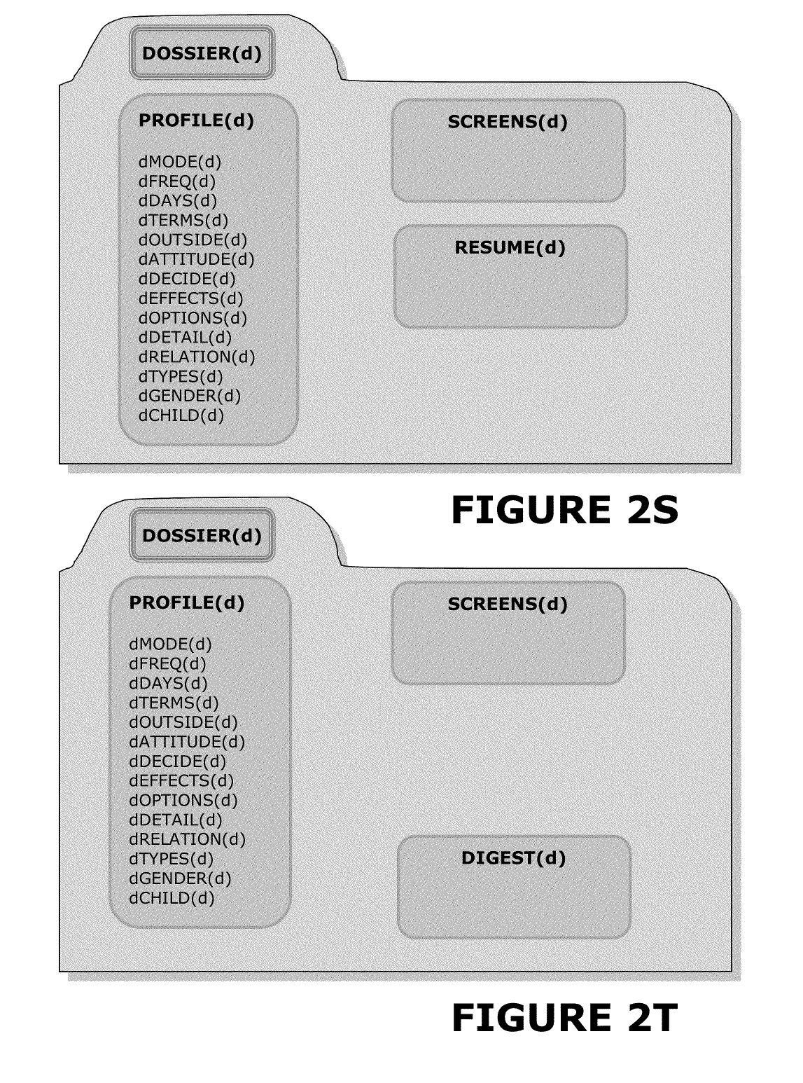

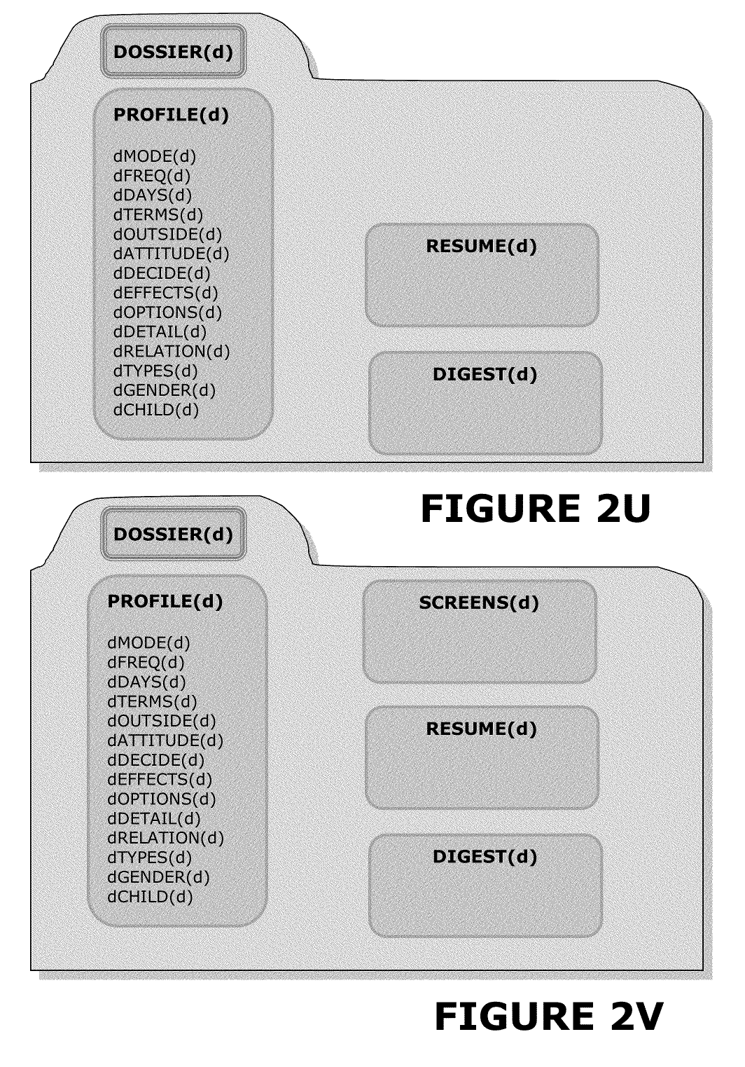

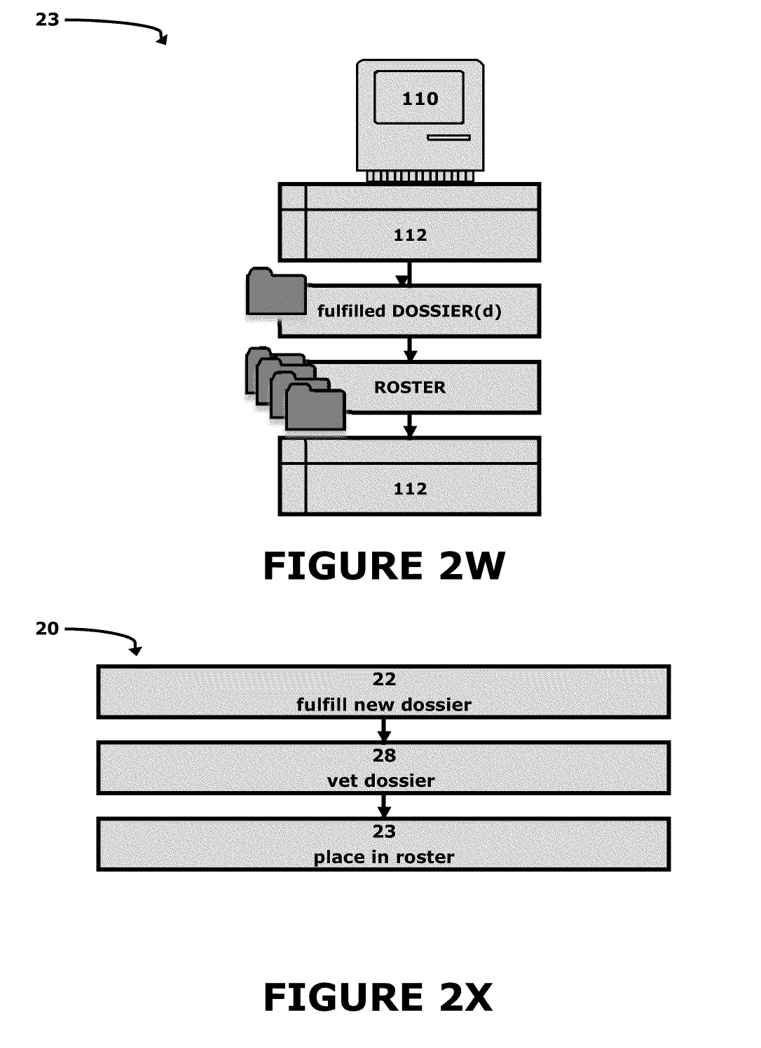

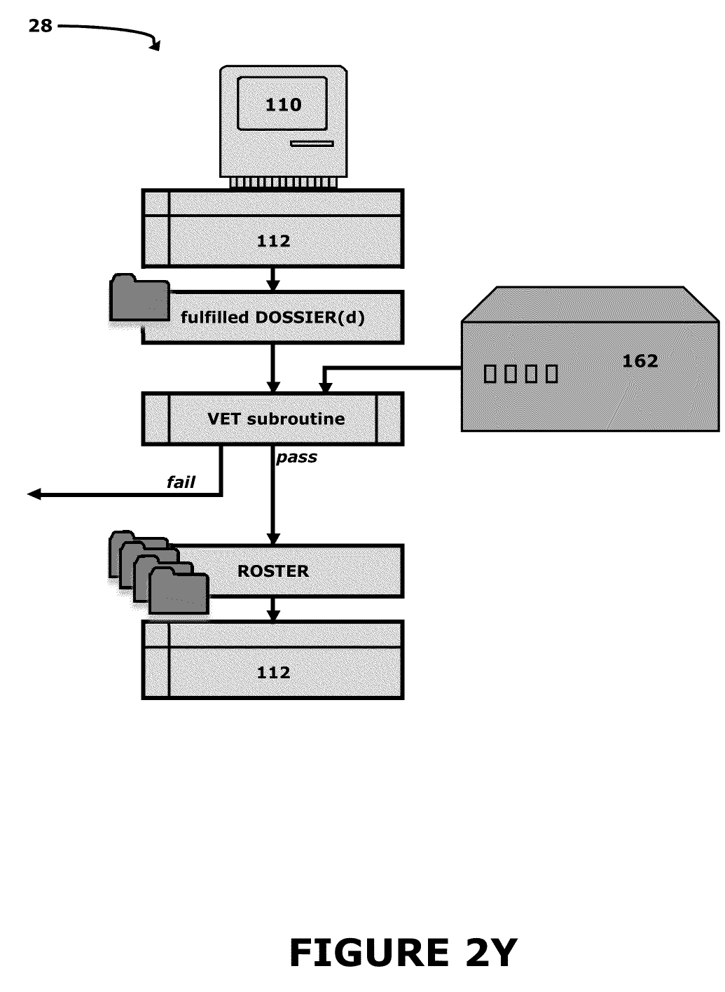

### (FIGS. 2A-2Y)

The roster comprises a plurality of doctor dossiers wherein each dossier pertains to an individual doctor. (FIG. 2A.) The roster, and the dossiers contained therein, can reside within the storage site 112 of the server 110.

The number of dossiers encompassed by the roster will depend upon its demographics. For example, the roster could include thousands of doctor dossiers if it has a national scope and/or if it is not confined to a certain institution or a given geographic area. The roster could instead contain hundreds of doctor dossiers if it is limited to one hospital or one geographic area. And a roster covering a small specialty practice could include only four or five doctor dossiers.

The roster-attaining step 20 can comprise a step 21 of opening a new dossier, a step 22 of fulfilling this dossier, and a step 23 of placing the fulfilled dossier in the roster. (FIG. 2B.) These steps are reiterated for each dossier until the roster is complete.

The new-dossier-opening step 21 can comprise the doctor computer 120 interfacing with the server 110. The server 110 prompts the computer 120 to indicate that he or she is doctor. When the computer 120 so indicates, the server 110 prompts the computer 120 as to whether this doctor needs a new dossier. Upon an affirmation input at the computer 120, the server 110 opens a new dossier and gives it a unique identifier. (FIG. 2C.)

The dossier-fulfilling step 22 comprises a step 24 of producing a personality predisposition profile for insertion in the dossier. (FIG. 2D.) The profile includes information pertaining to the doctor's predisposed personality traits. This information can include, for example, the doctor's communication customs, terminology tempo, receptiveness to outside influences, attitude-determining approach, decision demeanor, explanation etiquette, relationship association, treatment tendencies, and/or lifestyle logistics.

The purpose of the profile is to establish a doctor's predisposed personality traits, as opposed to evaluating his or her ability to modify one or more of these traits. Accordingly, the informatics within a doctor's personality profile is preferably primarily one-dimensional. It is not scored for importance or otherwise weighted by the doctor so as to accurately reflect his or her personality predispositions.

The communication-customs information can contain the doctor's preferred communication mode (dMODE, e.g., phone; E-mail; texting; Instant Message); the doctor's typical communication frequency (dFREQ, e.g., multiple times per week; once per week; a few times per month; once per month; a few times per year; only when necessary), and/or the doctor's regular response days (dDAYS, e.g., weekdays; weekends and off-days; weekdays and weekends, but not off-days; normally scheduled work days only).

The terminology-tempo information can involve the technical content a doctor prefers use in discussions with a patient (dTERMS, e.g., simple language; some medical terminology; a moderate amount of medical terminology and jargon; mostly medical jargon; and only medical jargon).

The outside-influence information can concern a doctor's stance towards other supplemental caregiver services (dOUTSIDE, e.g., guidance on a patient's independent research; access to family or individual counseling; access to religious or spiritual counseling; a referral for a patient to seek a second opinion).

The approach-attitude information can include answers on a doctor's empathy with a patient (dATTITUDE, e.g., try and understand where my patient is coming from; reassure my patients when they show signs of doubt; address the concerns of my patient; be as straightforward as possible).

The decision-demeanor information can be directed towards the doctor's consideration of patient input (dDECIDE, e.g., infrequently, unless their concerns have merit; some of the time, but only when necessary; some of the time, though their input is always valuable; frequently, and their input is key to my suggested treatment).

The explanation-etiquette information can involve the expounding on potential side effects of a patient's treatment options (dEFFECTS, e.g., in very little detail; with some detail, but not in depth, with a moderate level of relevant detail, with a high degree of detail; at length covering all detail). It could include the explanation of treatment options (dOPTIONS, e.g., all possible treatment options, even those I would not recommend; treatment options I think are best; the best two or three treatment options; the best possible treatment directly). Explanation-etiquette information can comprise the doctor's preferred detail level (dDETAIL, e.g., in the simplest terms; with some detail; with a moderate amount of detail; using lots of detail; with in-depth detail).

The relationship-relevance information can reveal the doctor's preferred relationship with a patient (dRELATION, e.g., friend, with whom my patients can share anything; guide, walking my patients through everything; mentor closely advises my patients; coach, informing and motivating my patients; teacher, educating my patients).

The profile-producing step 24 can comprise the server 110 prompting the computer 120 for personality-predisposition-profile inquiries for a plurality of items. The answers input at the computer 120 are conveyed to the server 110 for production of the doctor's personality-predisposition profile. (FIG. 2E.)

The dossier-fulfilling step 22 can comprise a step 25 of supplying screening statistics to the doctor's dossier. (FIG. 2F.) Screening statistics would be conditions that could cause a doctor to be irrelevant in the patient's selection, regardless of his or her ranking. Screens can include, for example, whether a doctor is accepting new patients, and/or a doctor's specialty. Other screening statistics could relate to doctor-patient distance (e.g., address, zip code, geographic coordinates, etc.). And/or the screening statistics can include insurance information as to accepted health insurance policies and/or a doctor's status with the relevant insurance carrier.

The scope and style of the screening statistics will depend upon roster demographics. For example, if the roster contains only doctors from a single-site practice, location statistics can be skipped. Likewise, if the roster is limited to doctors of a certain specialty, this screen could be eliminated. And if the roster is an insurance carrier's inventory of its associated doctors, insurance information would not necessary.

The dossier-fulfilling step 22 can include a step 26 of relaying the doctor's medical resume or a step 27 of directing a doctor's digest narrative to his or her dossier. (FIG. 2G and FIG. 2H.) The medical resume can include information such as the doctor's specialty, subspecialty, hospital affiliations, qualifications, education, awards and/or accolades. The narration can include details to be delivered in a digest to potential patients, such as photographs, website addresses, office directions, and other public-relations material.

The screening statistics can be input at the computer 120 by the doctor (or someone associated therewith) and conveyed to the server 110 (FIG. 2I). Unlike the personality-predisposition-profile inquiries, the doctor need not be individually involved in the supply of screening statistics. Accordingly, they could also or instead be transferred to the server 110 from an external database residing on a server 162. (FIG. 2J.) Likewise, the resume recitals and digest narrations can be input at computer 120 and/or transferred from a remote server 162. (FIGS. 2K-2N.)

Thus, a fulfilled dossier will always include a personality-predisposition profile, and it can also include screen statistics, a medical resume, and/or a digest narration. (FIGS. 2O-2V.) In many instances, screening statistics may intersect with information in other sections of the dossier. For example, a “specialty” screen could also or instead be found in the medical resume and/or a “distance” screen could be deviated from an address in the digest. And a dossier with other information pertaining to the doctor is doable and may be desirable.

The dossier-to-roster step 23 can comprise the server 110 simply placing the fulfilled dossier in the roster. (FIG. 2W.) Alternatively, the dossier-to-roster step 23 can include a step 28 wherein the dossier is vetted before placement on the roster. (FIG. 2X.) The vetting step 28 can involve checking the dossier against a database (e.g., one residing in an external server 162) which would expose any criminal, civil, or license issues for the doctor. (FIG. 2Y.) If the dossier does not pass muster, it is not put on the roster.

### Profile-Obtaining Step 30

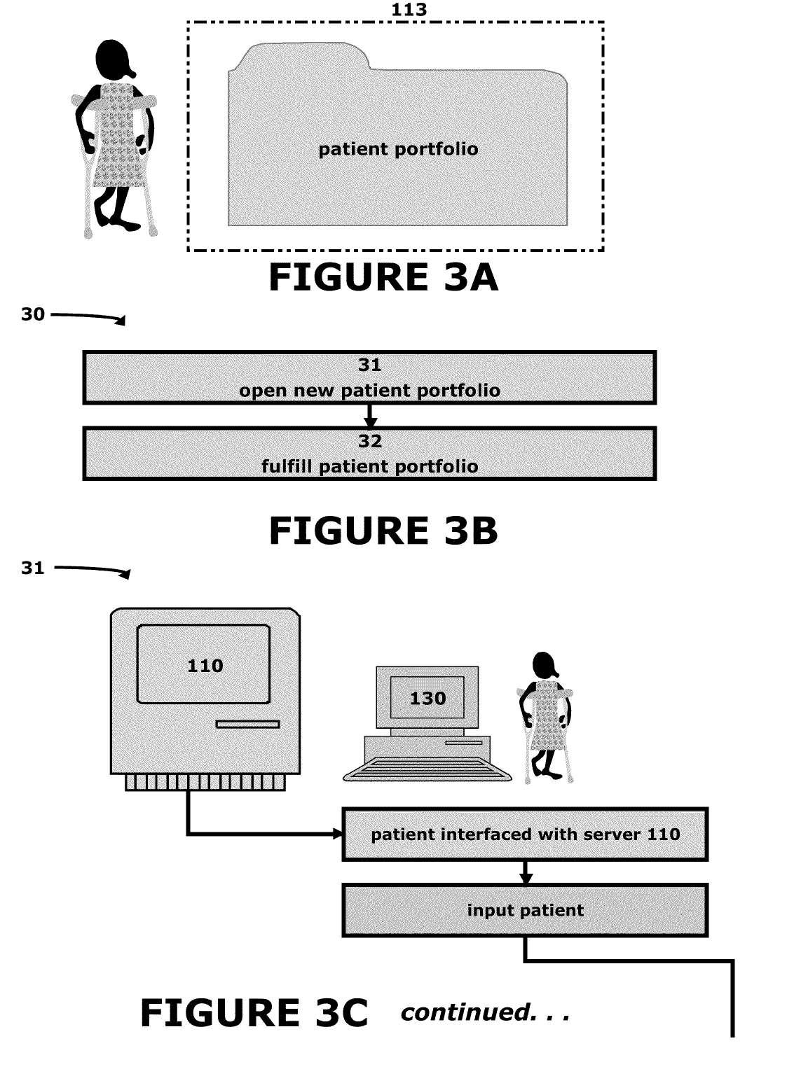

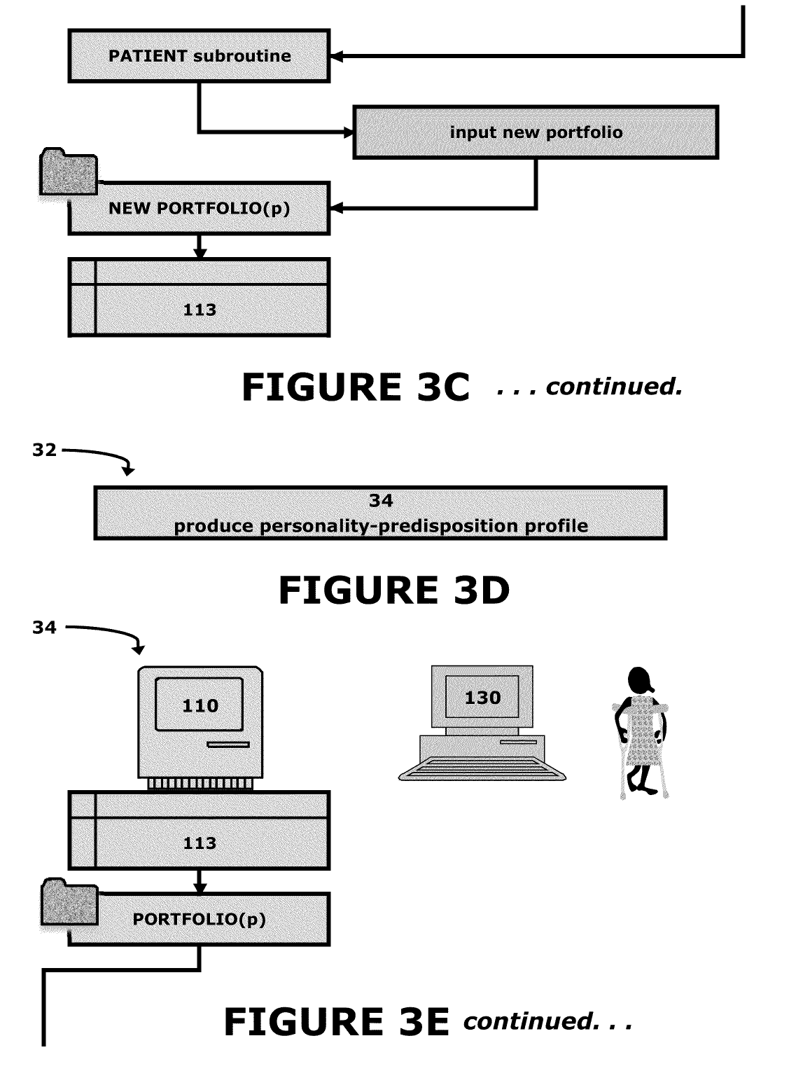

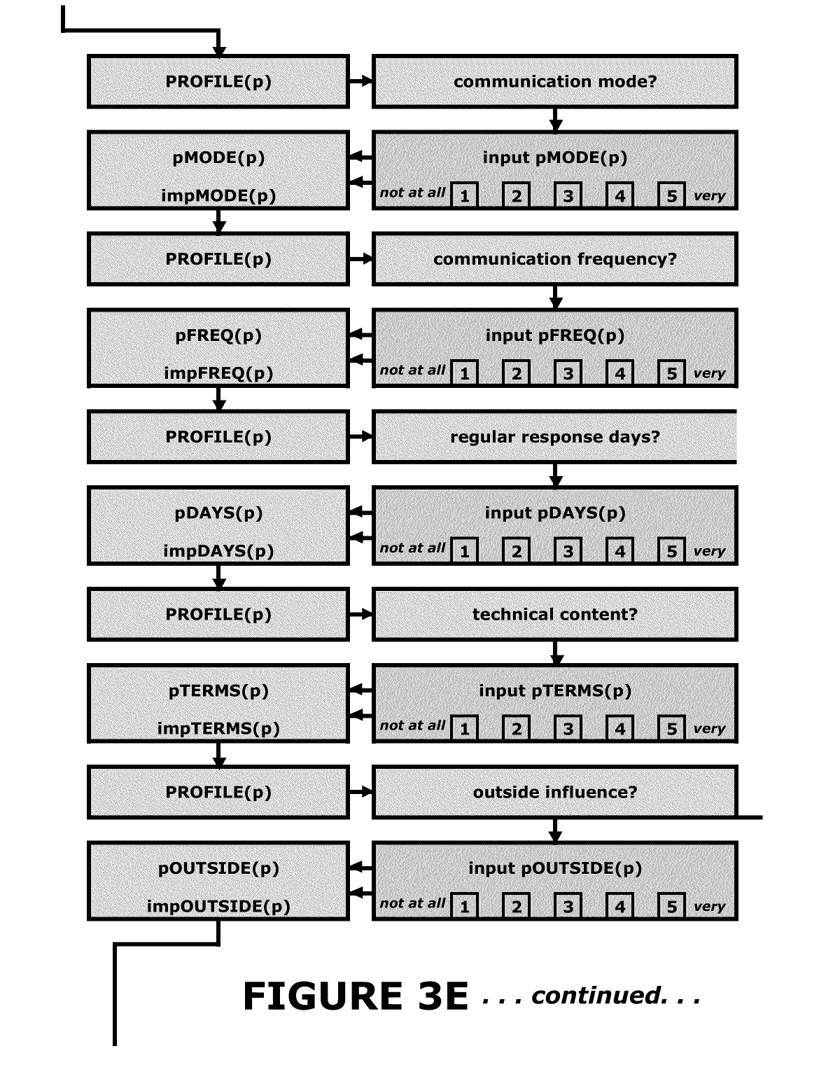

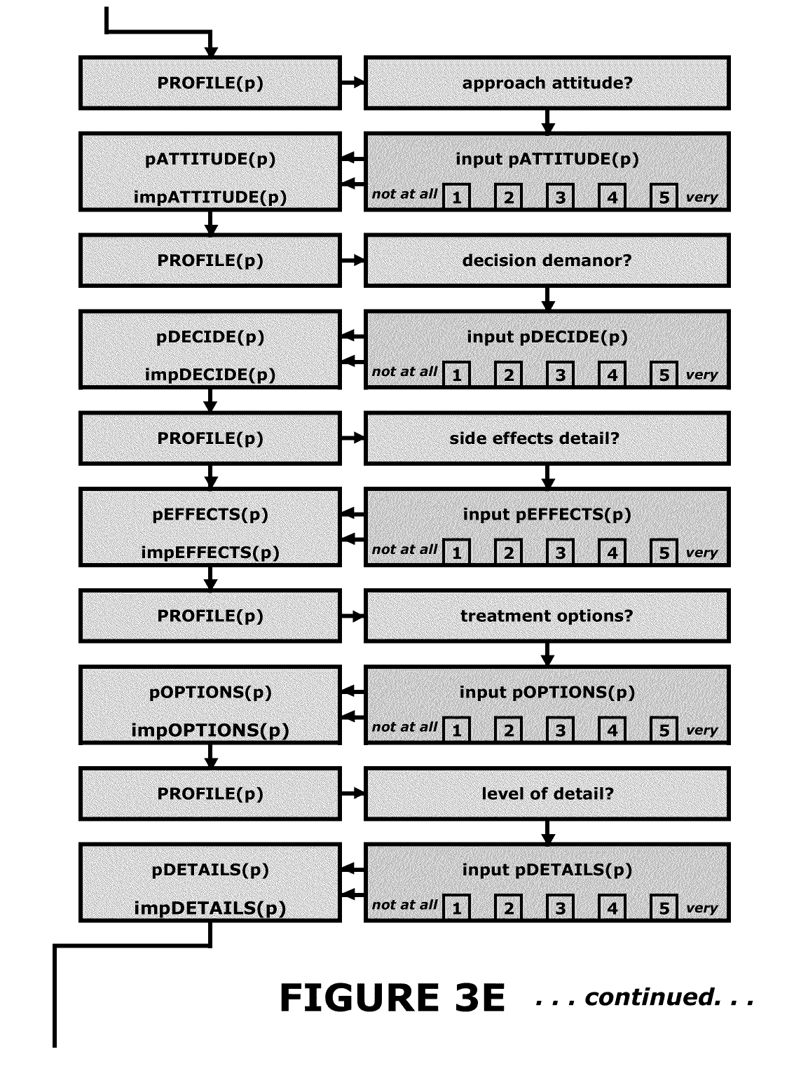

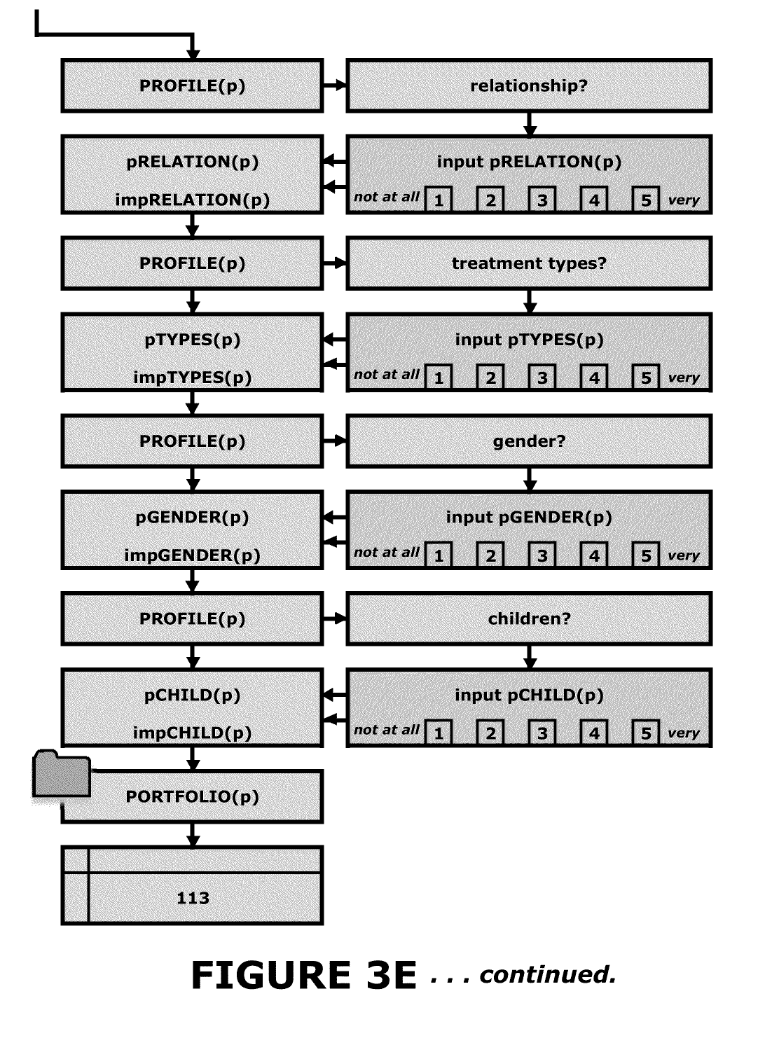

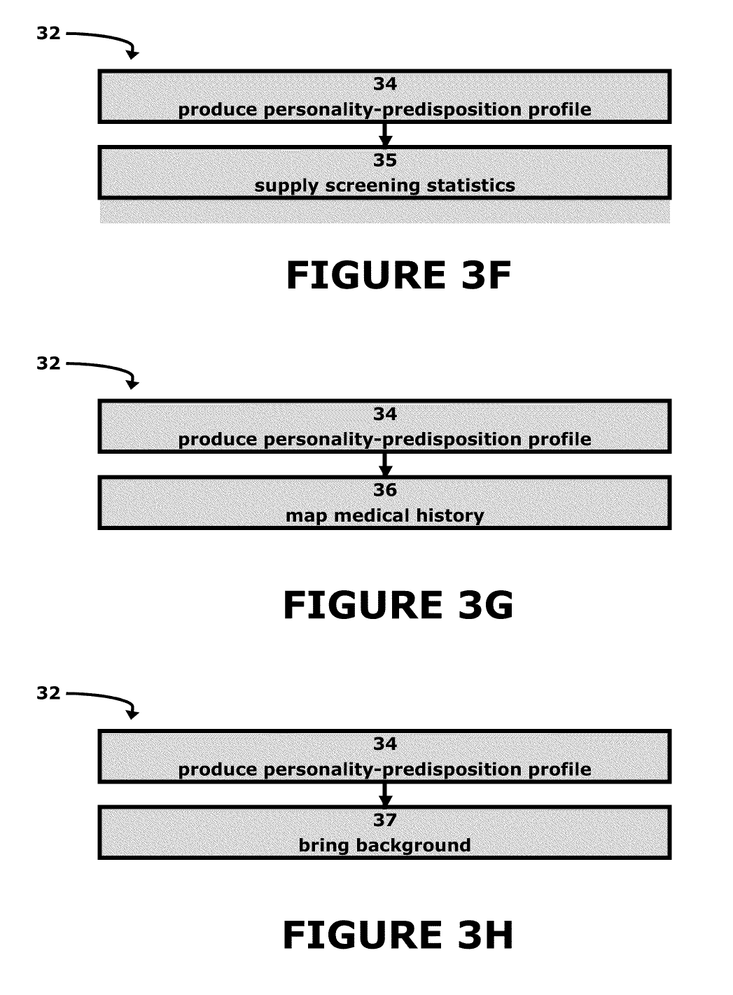

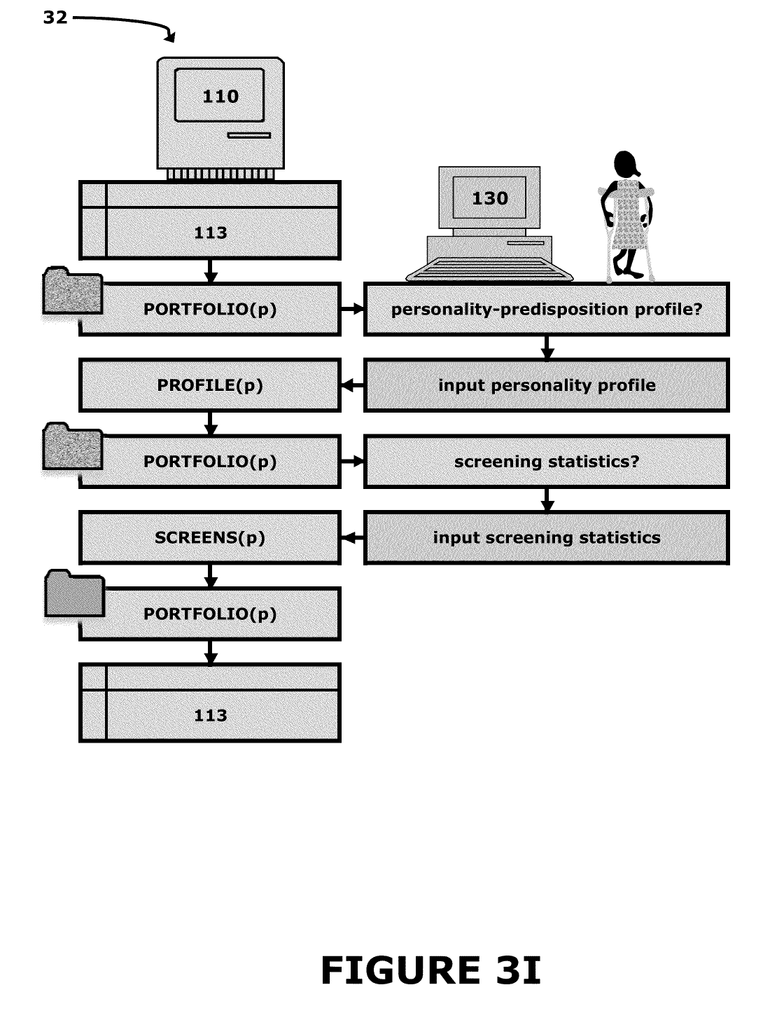

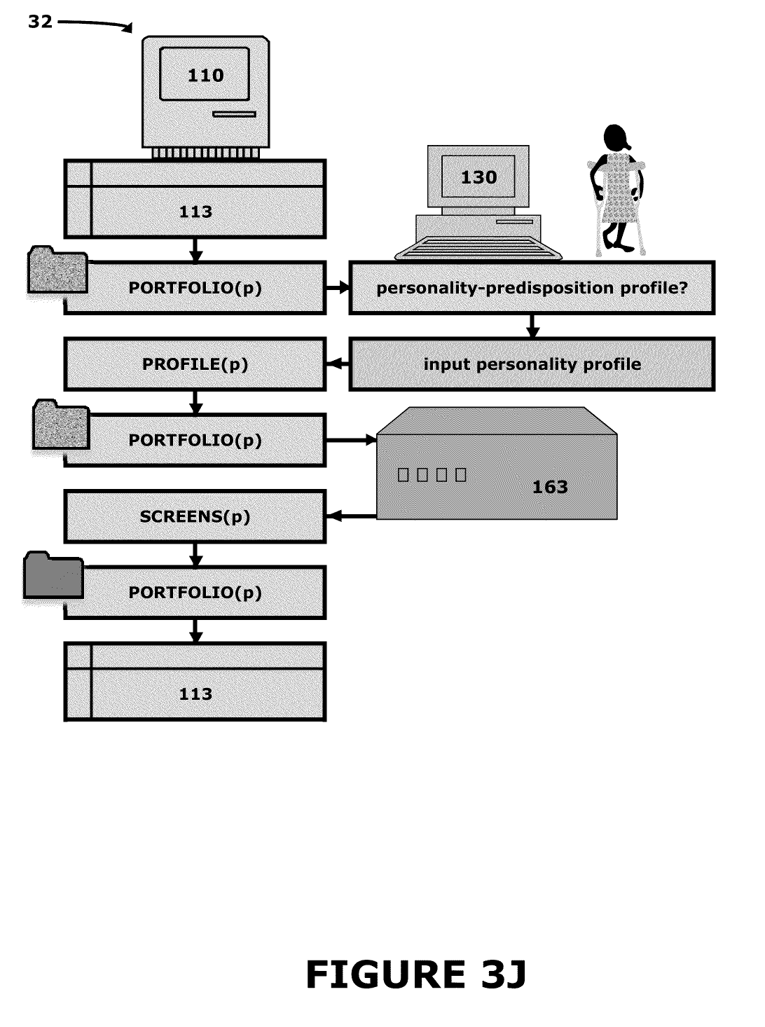

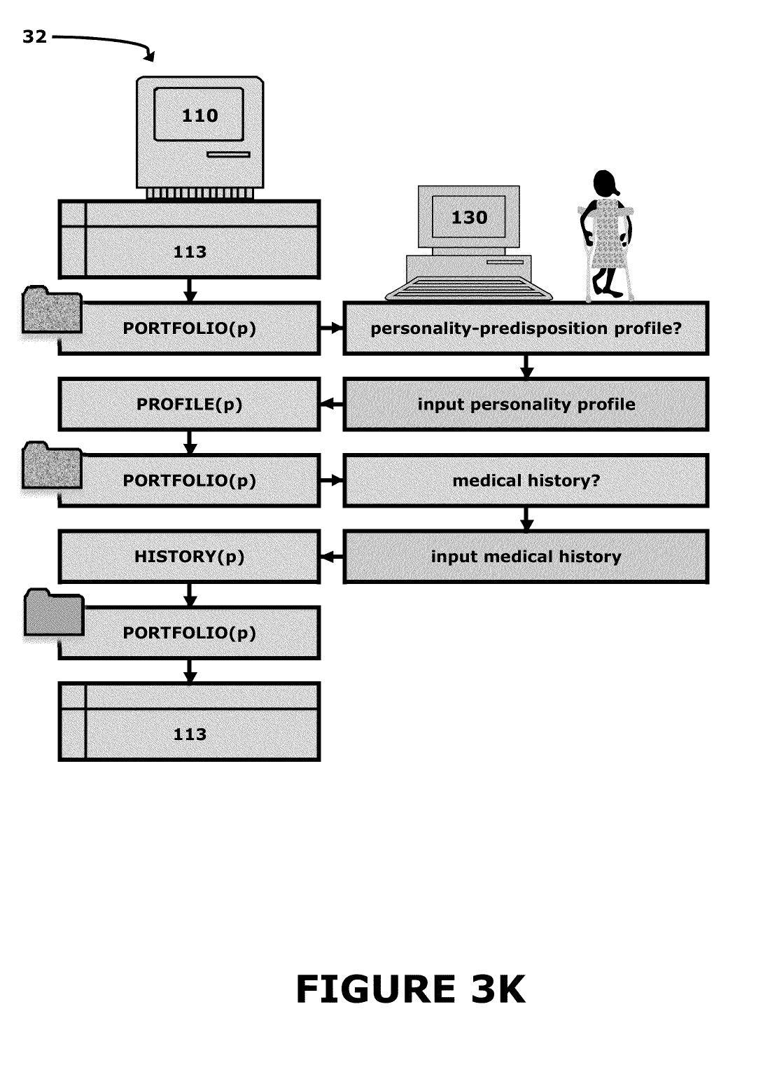

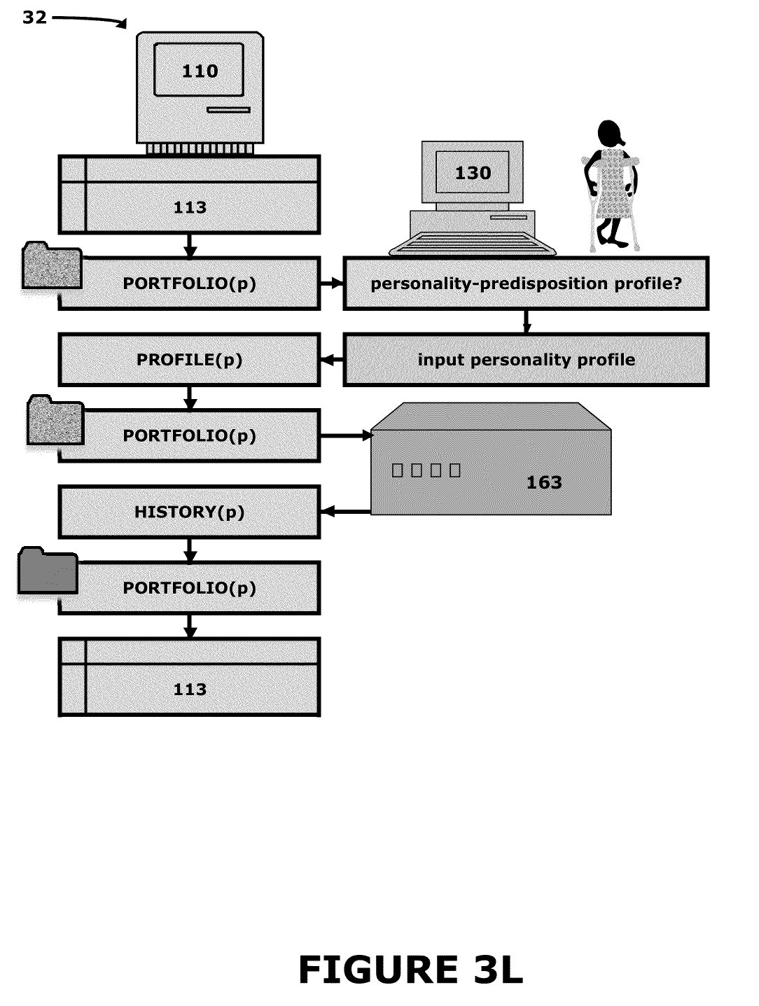

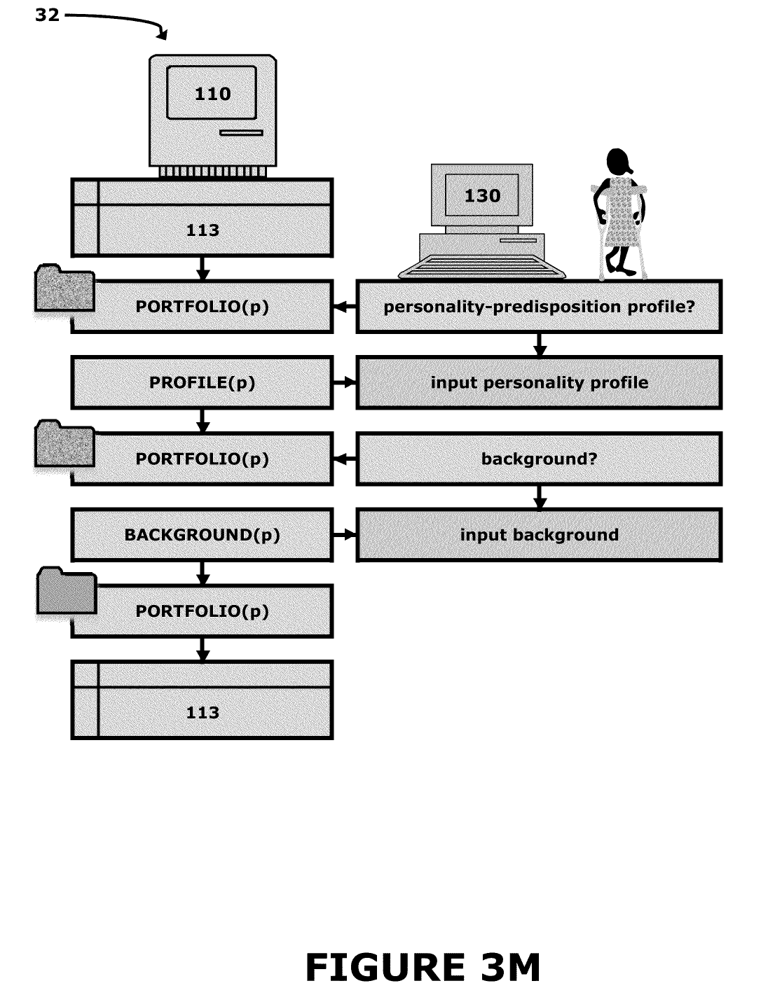

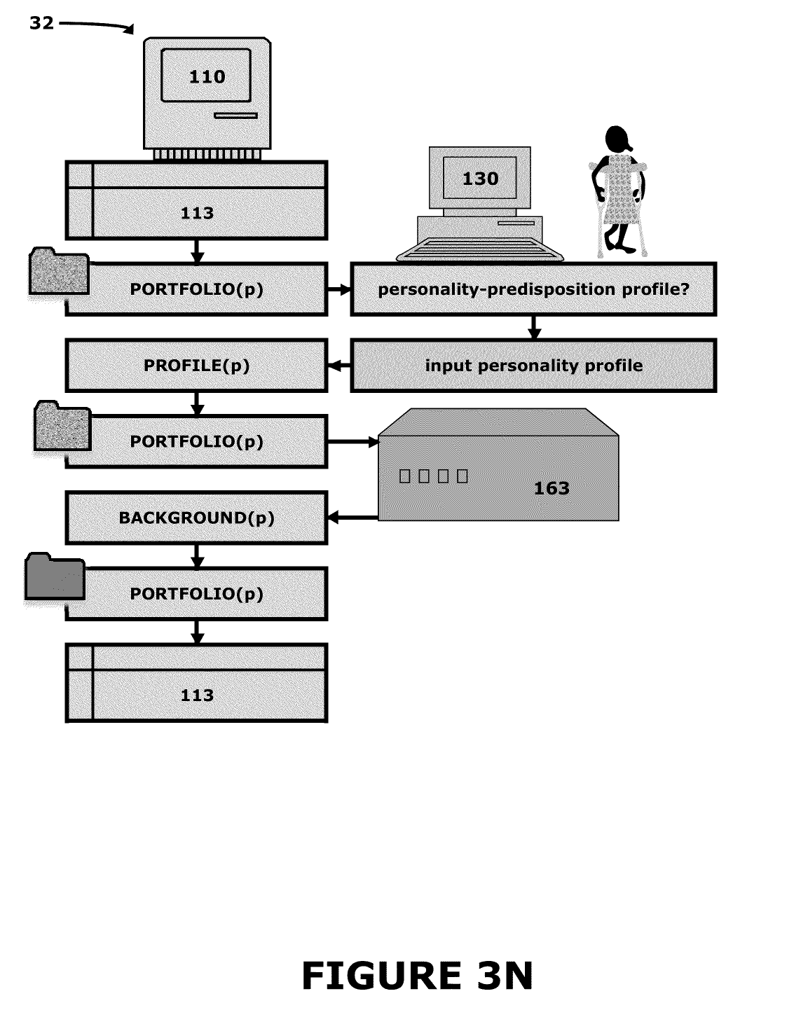

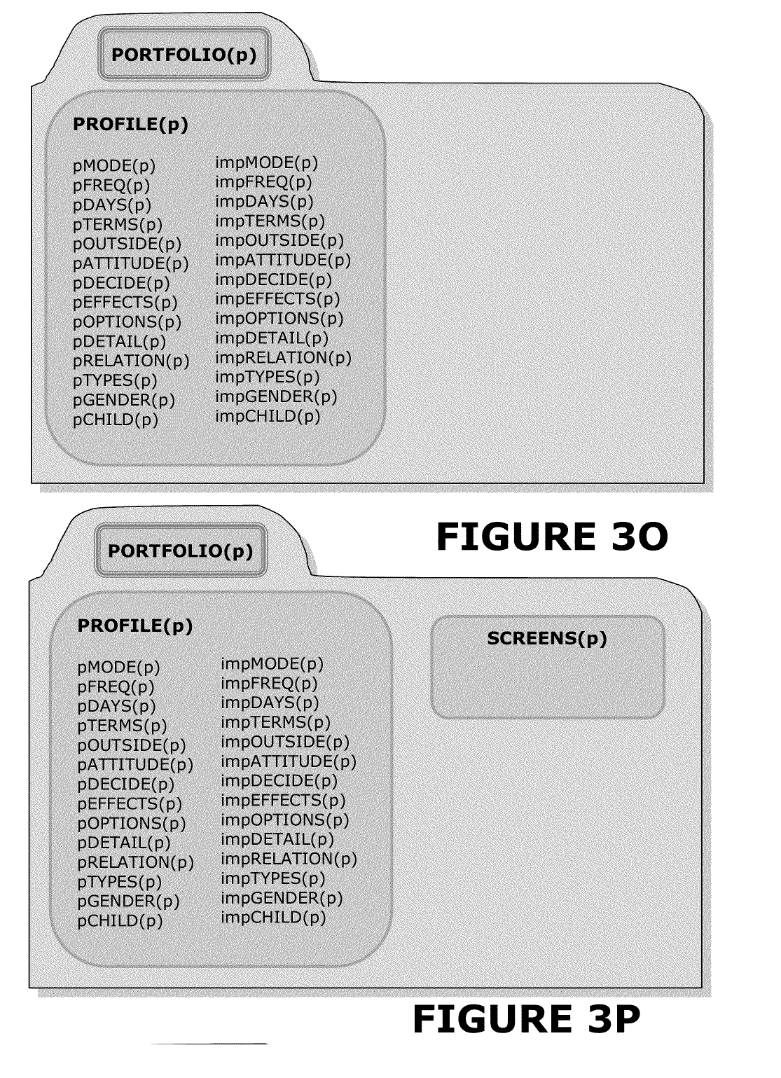

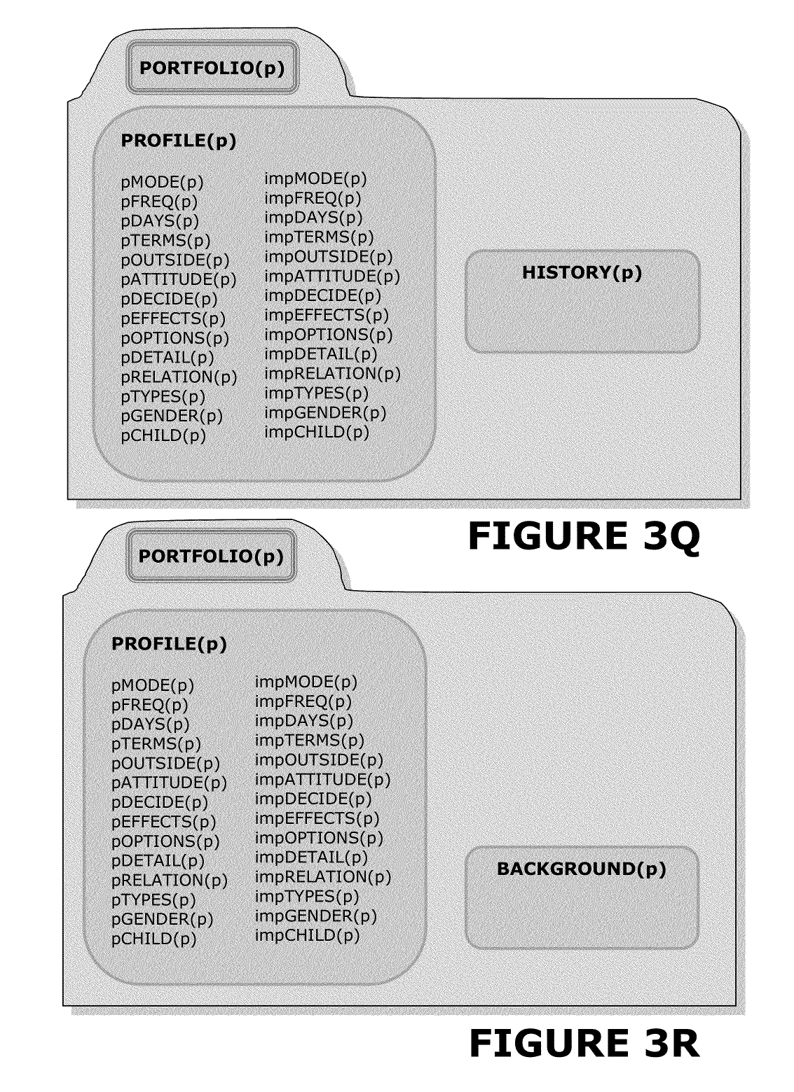

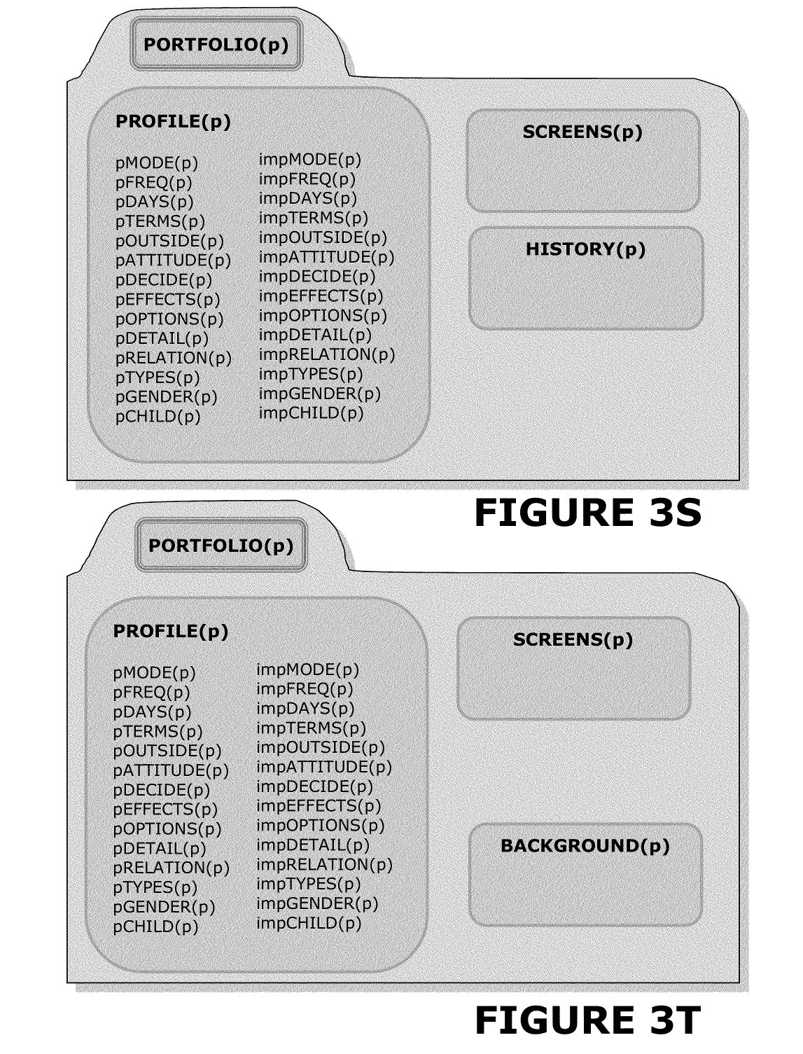

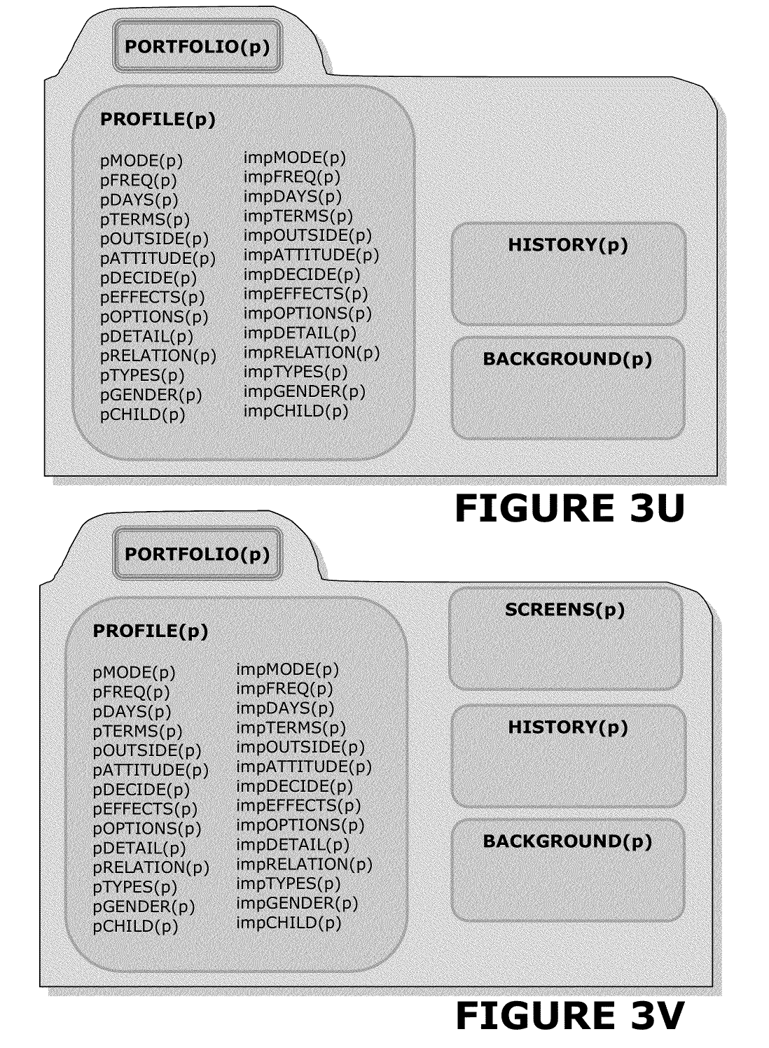

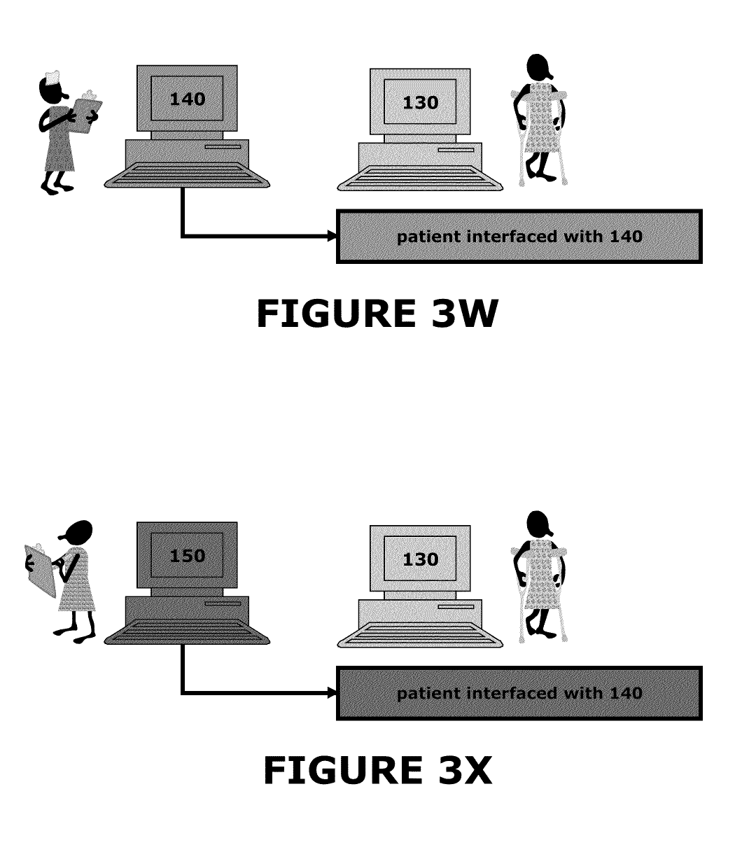

### (FIGS. 3A-3X)

The patient portfolio pertains to a particular patient and it can reside within the storage site 113. (FIG. 3A.) The storage site 113 can contain other portfolios for other patients, but only one patient portfolio is used when performing the steps of the system 10. The portfolio-obtaining step 30 can comprise a step 31 of opening a new portfolio for the patient and a step 32 of fulfilling the portfolio. (FIG. 3B.)

The new-dossier-opening step 31 can comprise the patient computer 130 interfacing with the server 110. (FIG. 3C.) Upon confirming the user is a patient, the server 110 prompts as to whether a new portfolio is needed. And upon verifying the need for a new portfolio, the server 110 opens a new portfolio. If the storage site 113 will contain other patient portfolios, the new portfolio can be assigned a unique identifier.

The portfolio-fulfilling step 32 comprises a step 34 of producing a personality preference profile for the patient. (FIG. 3D.) This profile is intended to outline the patient's preferred personality traits in a doctor. Thus, the information in the patient's profile parallels that in the doctor' profiles (or vice-a-versa). More specifically, for example, the patient's profile can include information about communication customs (e.g., pMODE, pFREQ, pDAYS), terminology tempo (e.g., pTERMS), receptiveness to outside influences (e.g., pOUTSIDE), attitude-determining approach (e.g., pATTITUDE), decision demeanor (e.g., pDECIDE), explanation etiquette (e.g., pEFFECTS, pOPTIONS, pDETAIL), relationship association (pRELATION), treatment tendencies (e.g., pTYPES), and/or lifestyle logistics (e.g., pGENDER, pCHILD).

As was indicated above, the doctors' personality profiles preferably do not include importance scaling, but are rather based on one-dimensional answers. In contrast, the information within the patient's profile can be deliberately importance scaled. Importance can be established, for example, with a Likert-like scale, asking the patient to select a number, a position, a shade, or other parameter on a spectrum spanning from “not at all important” to “very important.”

The importance-score shading of the patient's profile helps to reveal what the patient finds most significant in a productive doctor-patient relationship. For example, the patient may favor email communication (although telephone is fine too) but really needs a doctor who is willing to communicate on a daily basis. Thus, communication-mode issues would be given a low importance score and communication-frequency issues would be given a high importance score.

The profile-producing step 34 can comprise the server 110 prompting the computer 130 for personality-preference-profile inquiries for the same plurality of items as in the doctors' profiles. (FIG. 3E.) Each inquiry also includes an additional probe for an importance score. The answers and scores are input at the computer 130 are conveyed to the server 110 for production of the patient's personality-preference profile.

The portfolio-fulfilling step 32 can comprise a step 35 of supplying screening statistics which correlate with at least a subset of the dossier screening statistics. (FIG. 3F.) As with the doctor's screening statistics, they can be input at the computer 130 and conveyed to the server 110, or they can be transferred to the server 110 from an external server 163. (FIGS. 3G-3H.)

The fulfilling step 32 can comprise the step 36 of a mapping the patient's medical history to the portfolio and/or the step 37 of bringing the patient's background to the portfolio. (FIGS. 3I-3J.) The medical history could contain, for example, the patient's immunizations, hospitalizations, family tree trends, past and present prescriptions, allergies, and/or surgeries. The background can comprise the patient's address, telephone number, emergency contacts, employer, insurance coverage, religion, and/or living will location. They can be input at the patient computer 130 or transmitted from an external server 133. (FIGS. 3K-3N.)

The patient portfolio will have a personality preference profile with an answer to each of the profile items along with an importance score for this item. (FIG. 3O.) Optionally, the portfolio can also include screening statistics, a medical history, and/or a background. (FIGS. 3P-3V). As with the doctor dossier, there may be some cross-pollination of screening statistics in the medical history and/or background. And a portfolio with other pertinent patient information is possible and predicted. The server 110 stores the patient portfolio (e.g., in storage site 113.)

As shown in FIGS. 3W-3X, the patient computer 130 can instead interface with the healthcare organization computer 140 or the insurance carrier computer 150 during the patient-profile-obtaining step 30. The computer 130/140 would then convey the portfolio to the server 110 for storage and use in the latter steps.

### Roster-Ranking Step 40

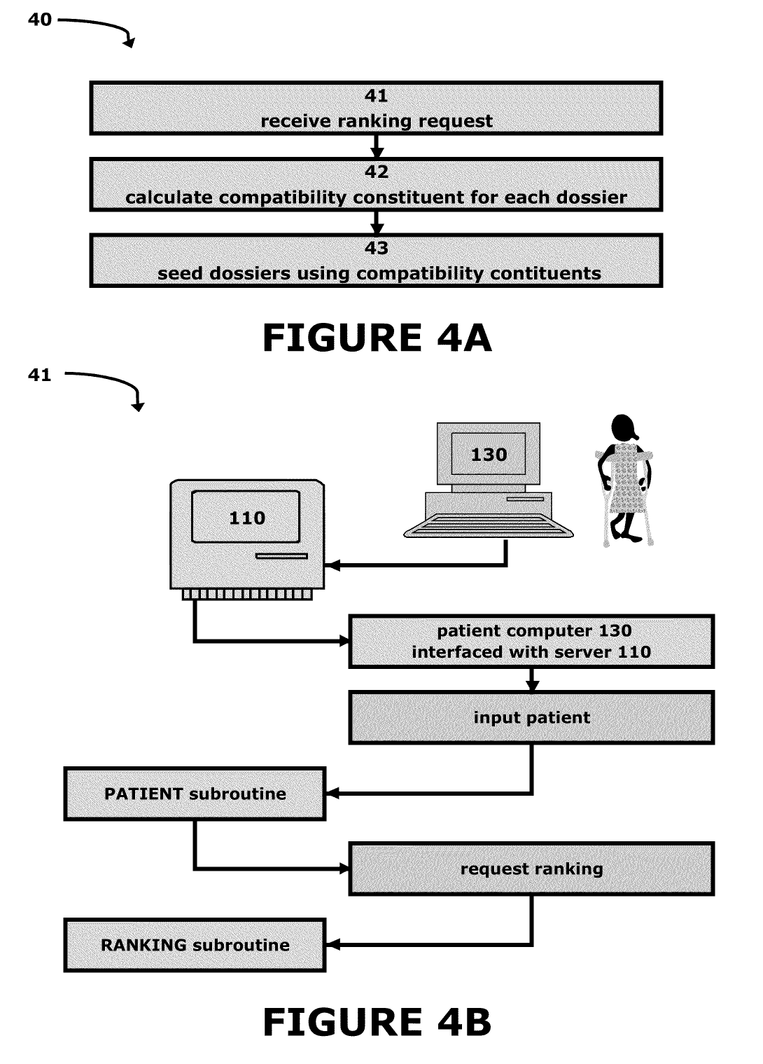

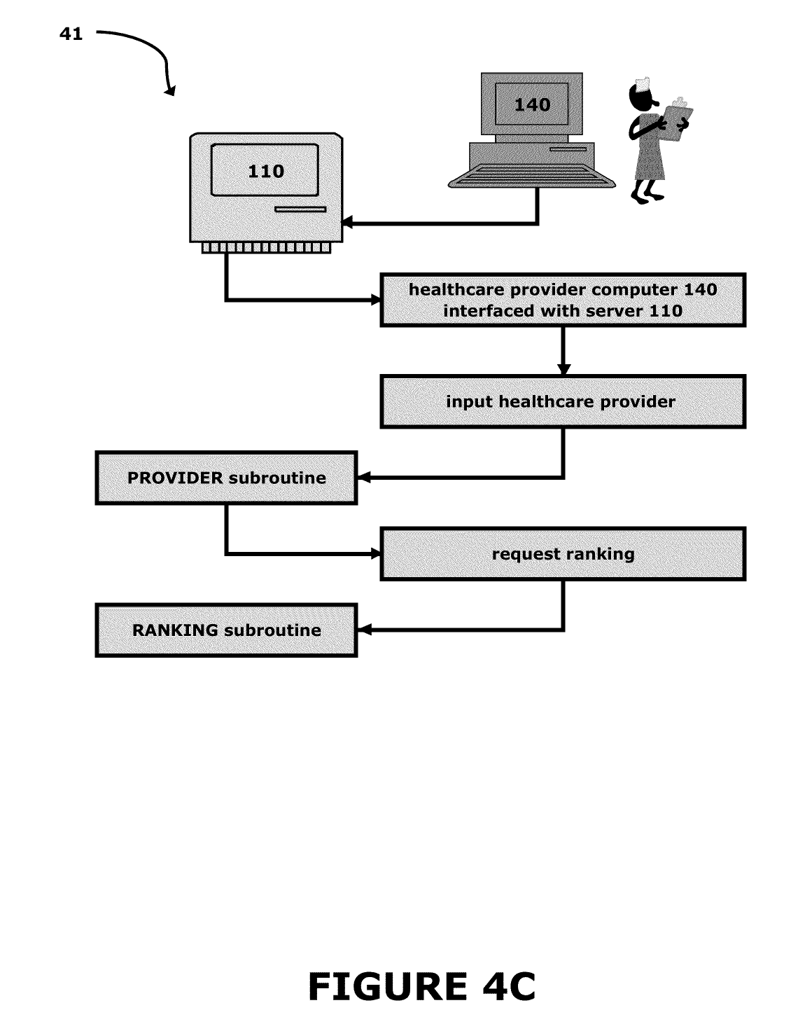

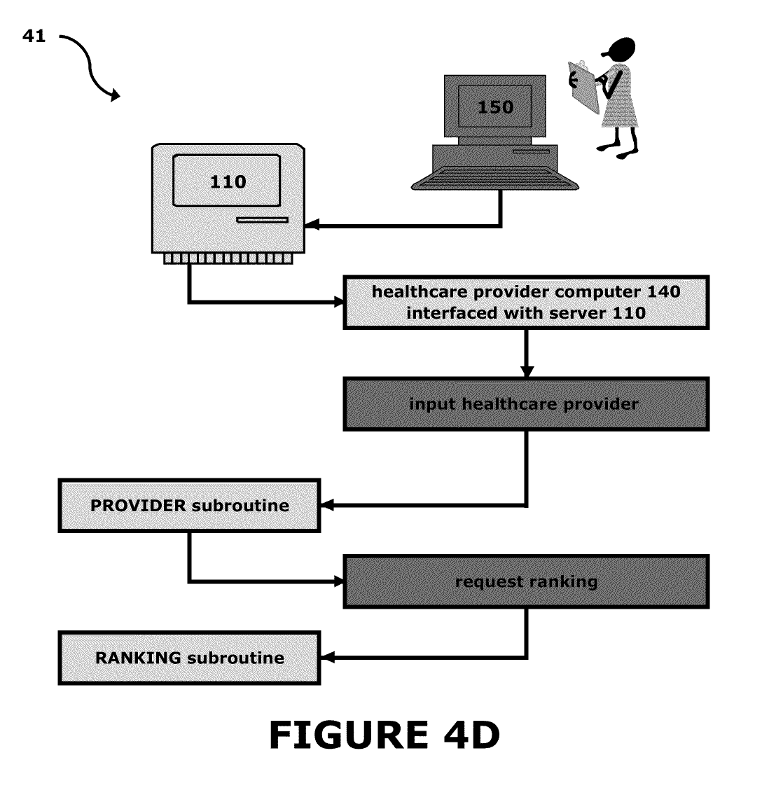

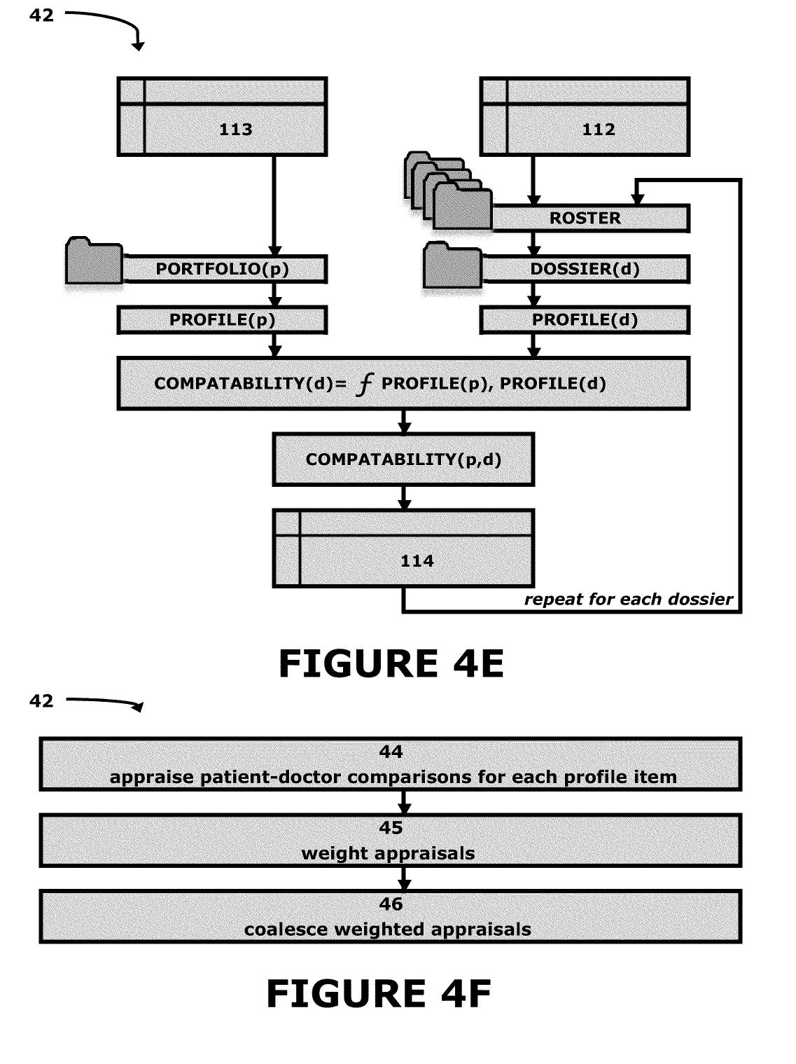

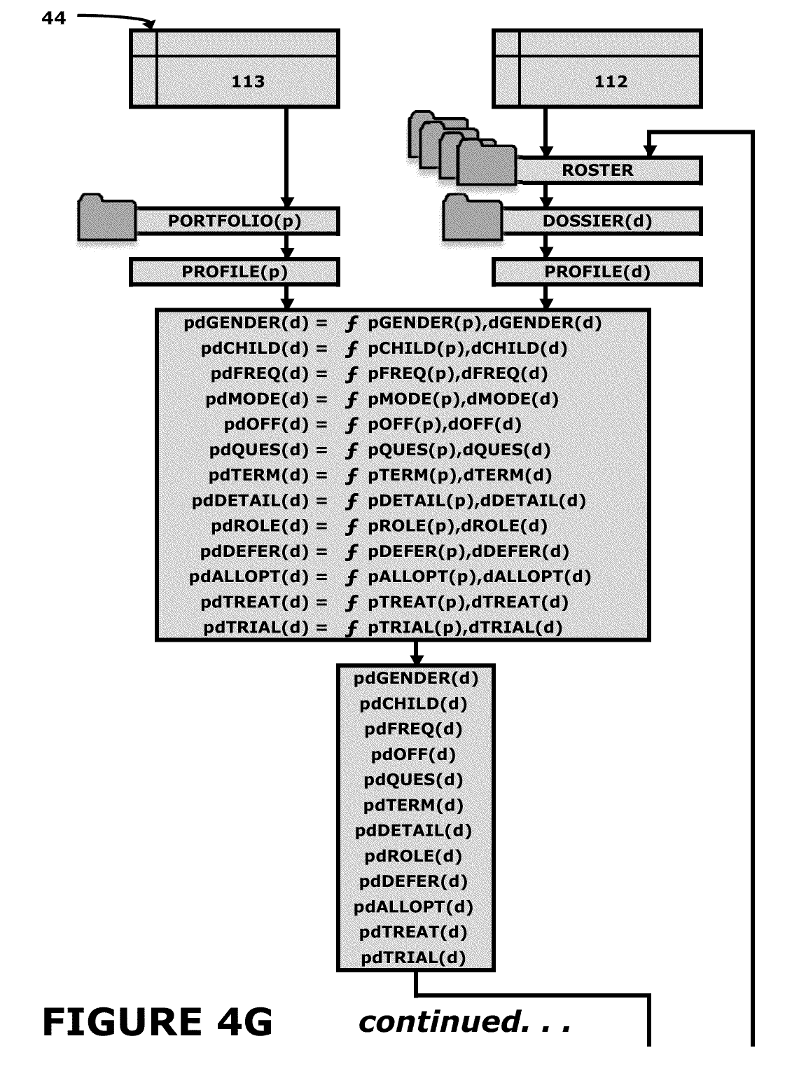

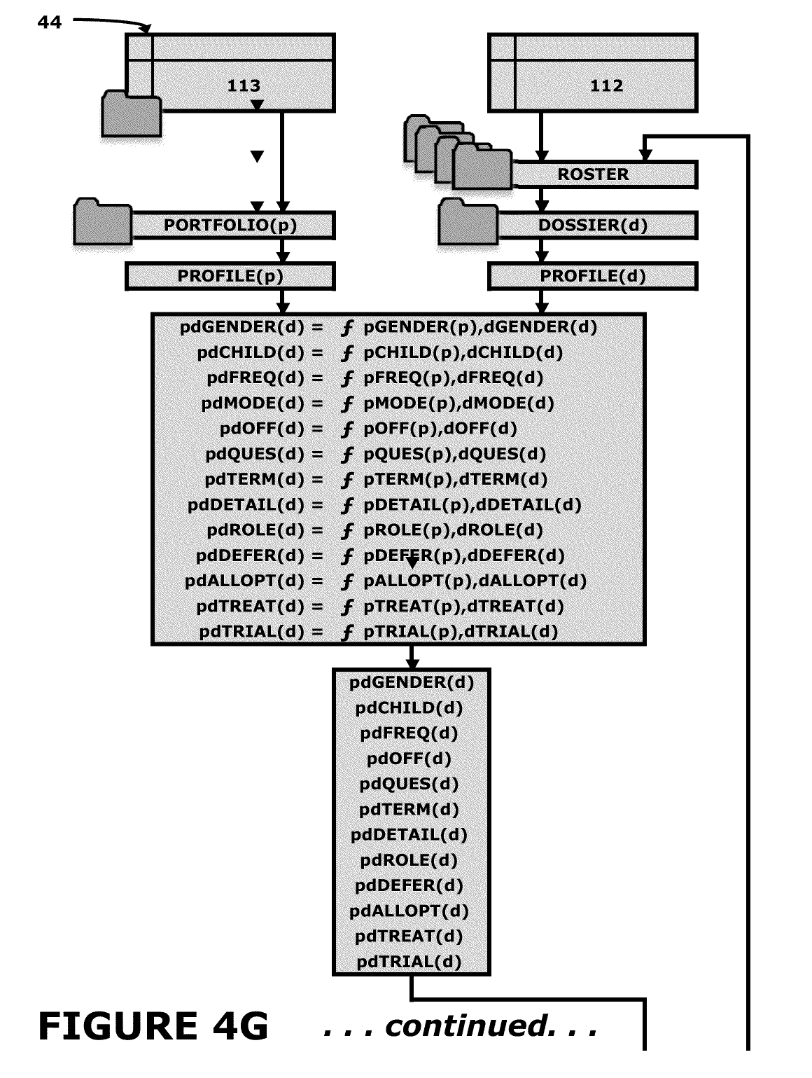

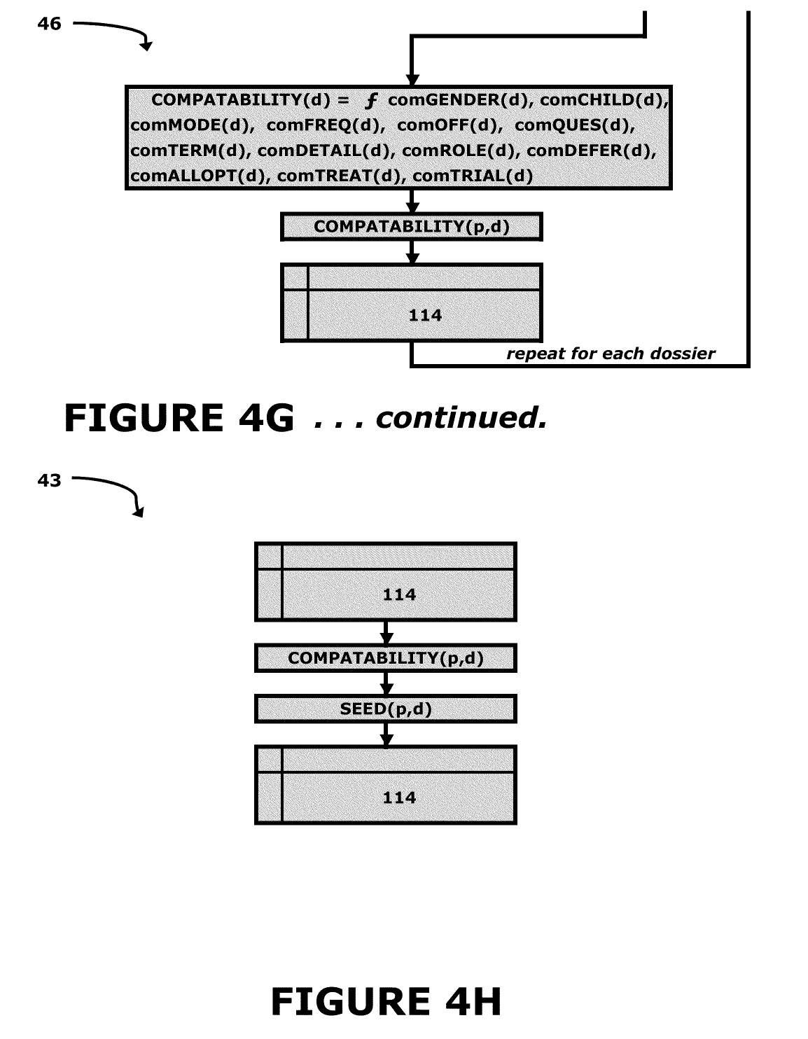

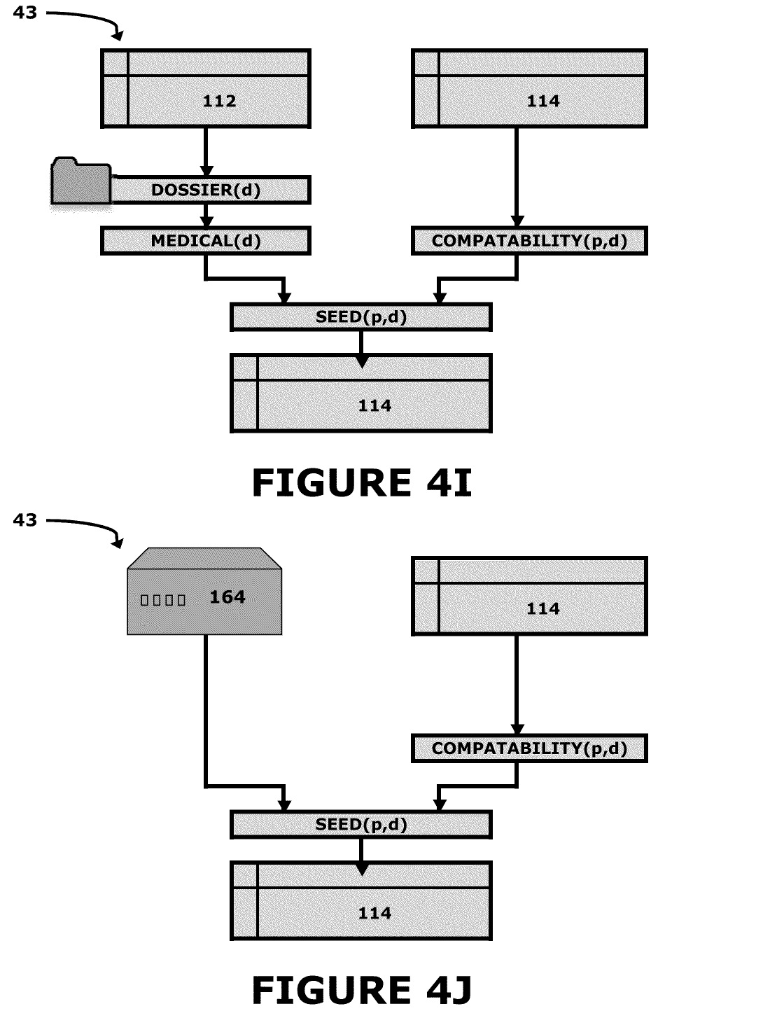

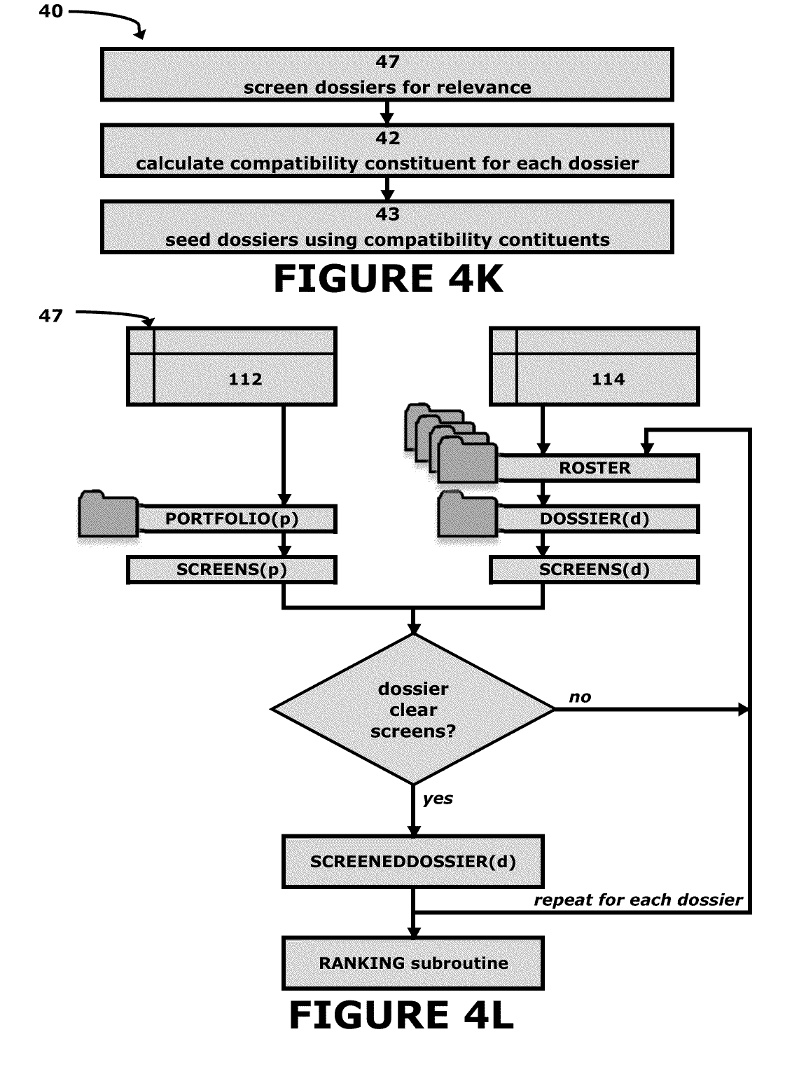

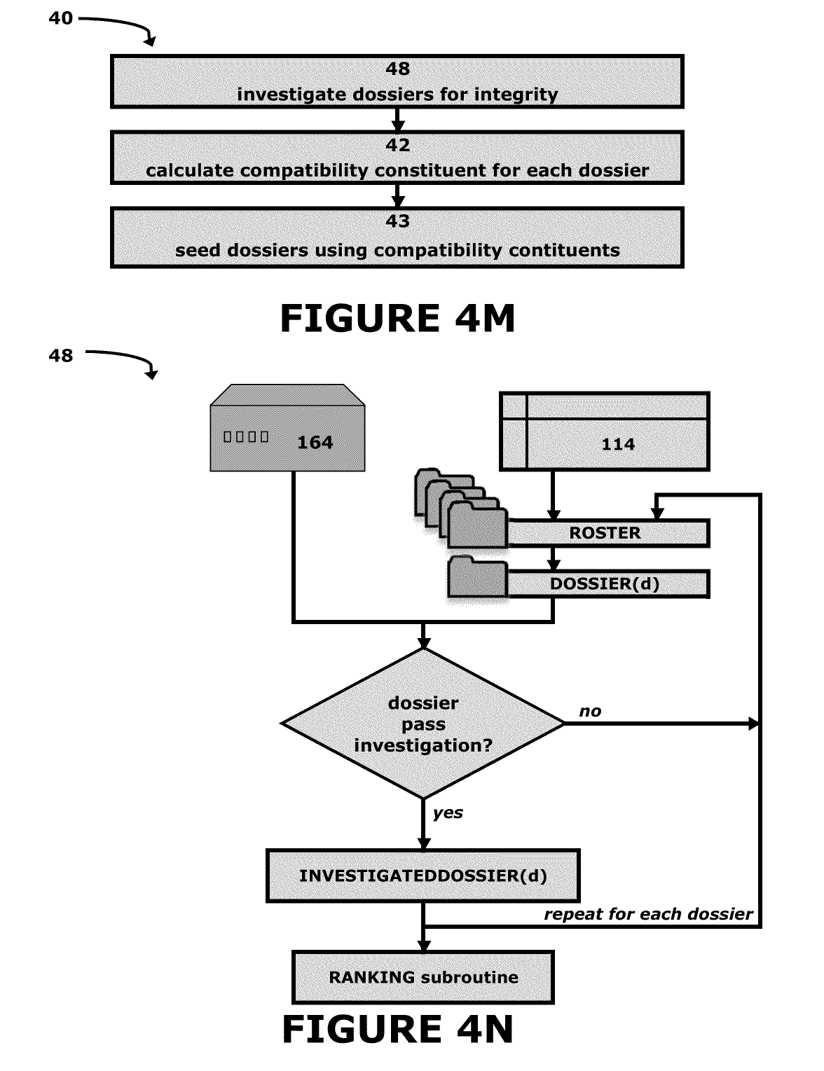

### (FIGS. 4A-4N)

The roster-ranking step 40 ranks the doctor dossiers in the roster according to the doctor's personality compatibility with the patient. This step 40 can comprise a step 41 of receiving a request to rank the roster, a step 42 of calculating a compatibility constituent for each dossier, and a step 43 of using the compatibility constituents to seed the dossiers. (FIG. 4A.)

The rank-request-receiving step 41 can comprise the patient, or someone associated therewith, accessing the website at a computer 130. The server 110 conveys the homepage to the computer 130, the user indicates that he or she is a patient, and then requests a ranking. Upon receiving this request, the server 110 initiates the ranking system. The ranking request can come from the patient computer 130, the healthcare organization computer 140, and/or the insurance carrier computer 150. (FIGS. 4B-4D.) Additionally or alternatively, the server 110 itself could initiate a ranking request, such as with an automatic transition from a roster-revising step 60 and/or a portfolio-updating step 70.

The compatibility-calculating step 42 generally comprises executing a function which yields a constituent measuring the compatibility of each doctor. The function draws upon the doctor's personality predisposition profile and the patient's personality preference profile to achieve this measurement. (FIG. 4D.)

The compatibility-calculating step 42 can more particularly include a step 44 of numerically appraising doctor-patient comparisons of each profile item, a step 45 of weighting these appraisals according to importance score, and a step 46 of coalescing the weighted appraisals. (FIGS. 4F-4G.)

The comparison-appraising step 44 can comprise contrasting each item in the patient's personality profile to the analogous item in each doctor's personality profile. And then the congruency between patient-doctor profile items is given a corresponding numeric value. In other words, the numeric appraisal is a function of the patient's answer to a profile item and a doctor's answer to this same profile item.

The appraisal-weighting step 45 can comprise weighting the profile-item comparison in a manner modeling the importance score given to this profile item by the patient. This weighting lets the patient's central concerns control calculations while inconsequential issues stay essentially dormant.

The coalescing step 46 can comprise assimilating the weighted appraisals for all of the profile items in each doctor dossier into an overall compatibility assessment called its compatibility constituent. Thus, at the completion of the compatibility-calculating step 42, each dossier has a compatibility constituent representing the corresponding doctor's potential of satisfying the patient's personality preferences.

The calculations involved in the comparison-appraising step 44, the appraisal-weighting step 45, and the coalescing step 46 are contingent upon the numeric conventions adopted. Greater numeric values can correspond to personality convergence and lesser numeric values can correspond to personality divergence (or vice-a-versa). Positive numbers can portray profile synchronization and negative numbers can portray profile discord (or vice-a-versa). Only integers can be used, only fractions can be employed, binary principles can be brought into play, and/or a range of real numbers can be relied upon in this analysis.

Numeric appraisals and/or importance scores can, but do not have to, pursue the same pattern for all profile items. Additionally or alternatively, the weighting step 45 can consist of mere multiplication and/or the coalescing step 45 can consist of primarily summing. But compatibility-calculating steps comprising more sophisticated patterns, elaborate equations, intricate formulas, complicated functions, ideal-doctor numerators, and/or multifarious algorithms are possible and predicted.

The dossier-seeding step 43 can comprise using only the compatibility constituents of the dossiers to solve their seed. (FIG. 4H.) Alternatively, the dossier-seeding step 43 can comprise using the compatibility constituents along with other non-profile information to seed the dossiers. This non-profile information can comprise, for example, facts from medical resumes and/or external databases. (FIGS. 4I-4J.) In either or any case, the compatibility constituents have a major influence in the seeding succession. Non-profile items can tune or temper compatibility-close dossiers, but they will not contradict the precedent set by the personality profiles.

The roster-ranking step 40 can comprise the step 46 of screening the dossiers for relevance. (FIG. 4K.) This screening step 46 could be performed using the screening statistics of the doctors' dossiers and/or the screening statistics of the patient's portfolio. (FIG. 4L.) If the screening statistics signify that a doctor will be unsuitable (regardless of personality-profile ranking), his or her dossier can be relieved from the rest of the ranking steps.

For example, if a doctor is not accepting new patients, there is no reason to proceed any further with this dossier. If the patient's portfolio specifies that a dermatologist is desired, only dossiers of dermatologic doctors need be advanced. Other filtering factors could be patient-doctor distance and/or health insurance coverage.

The roster-ranking step 40 can additionally or alternatively comprise the step 47 of investigating dossiers for integrity. (FIG. 4M.) The dossier-investigating step 47 can be performed via an external database (e.g., from server 164) which exposes doctors with criminal, civil, or medical license problems. (FIG. 4N.) If the investigation implies that a doctor has integrity problems, he or she can eliminated from the ranks.

The screening step 46 and/or the investigating step 47 can be performed before the compatibility-calculating step 42. This early-stage approach avoids putting irrelevant dossiers through the rigors of later ranking steps. But one or both of these steps could be carried out after the calculating step 42, if spending programming power on immaterial dossiers is not a drain on resources.

### Rank-Reporting Step 50

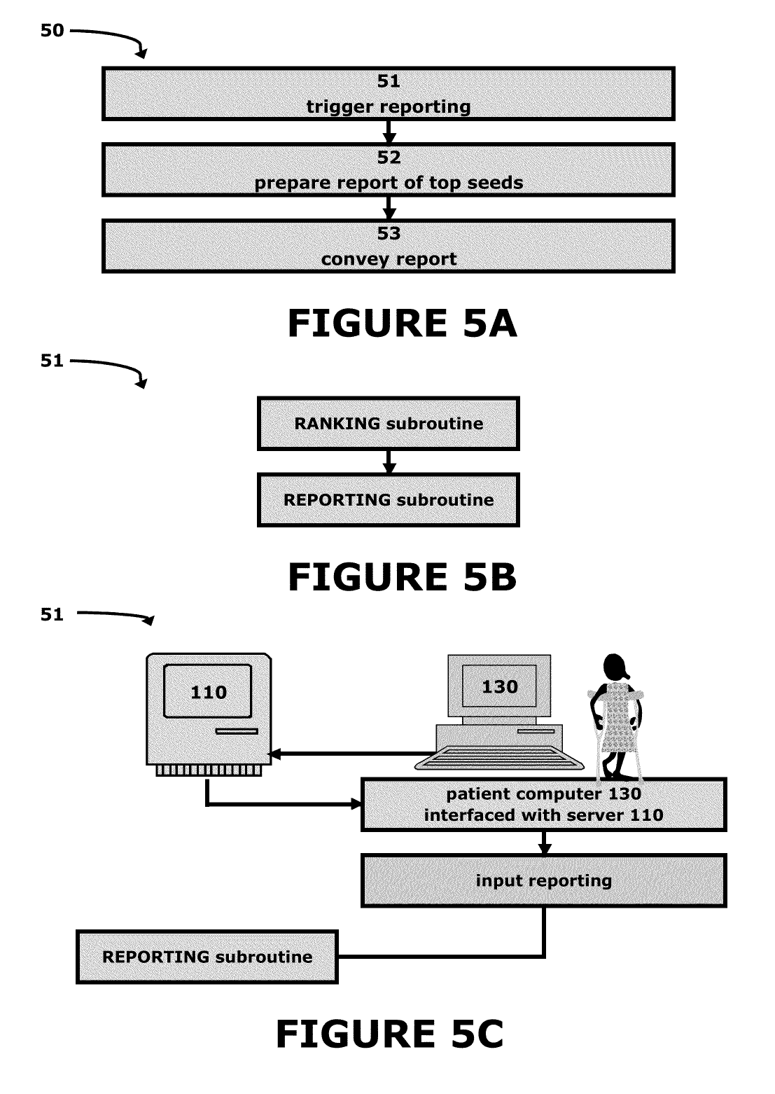

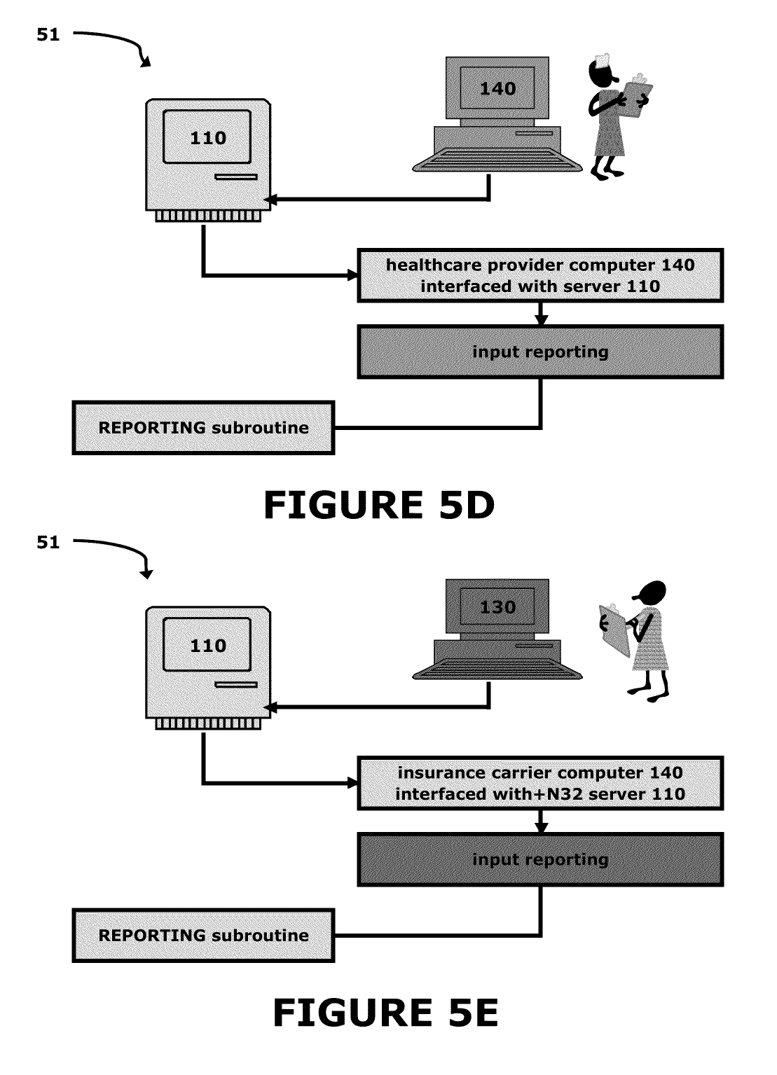

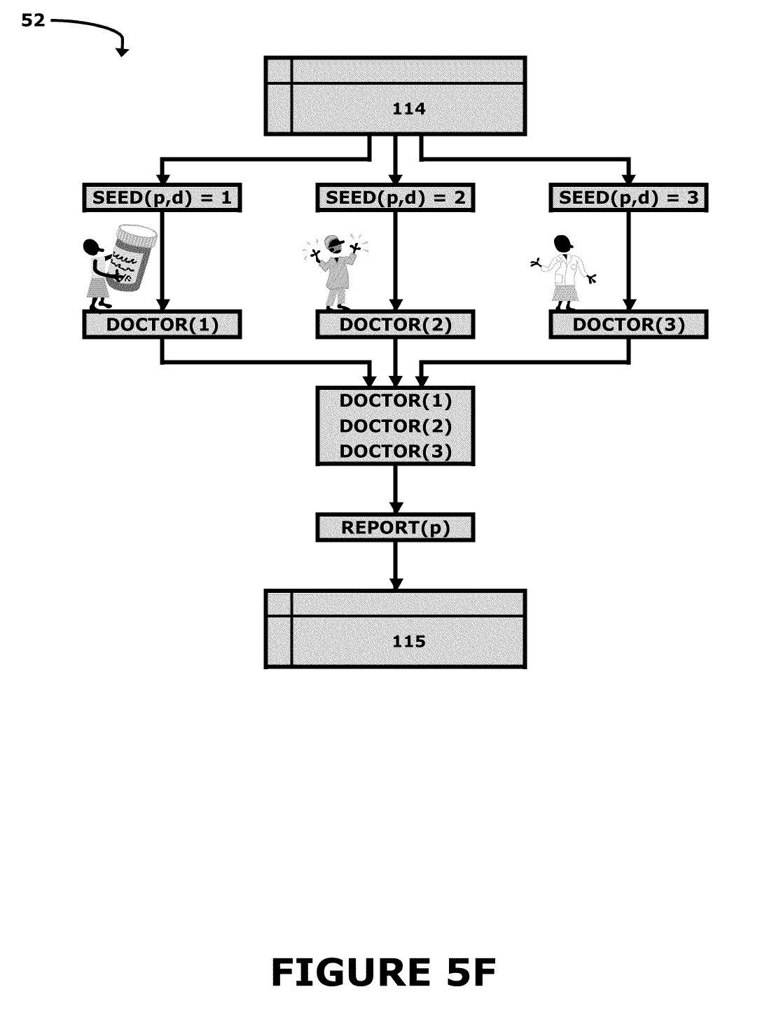

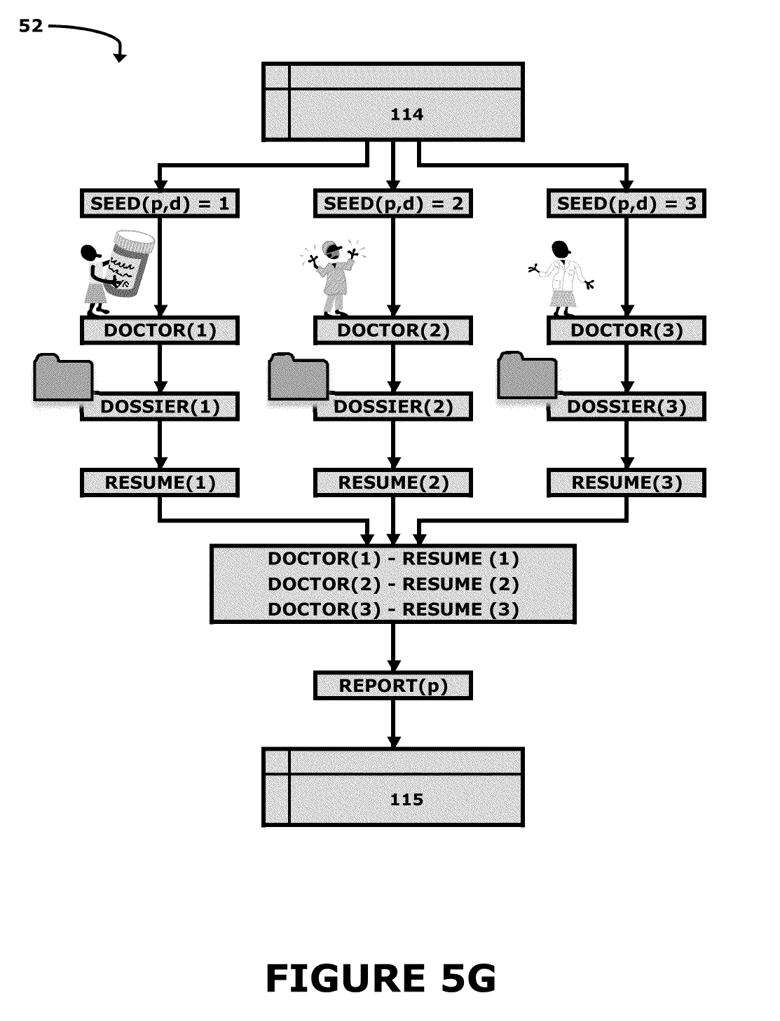

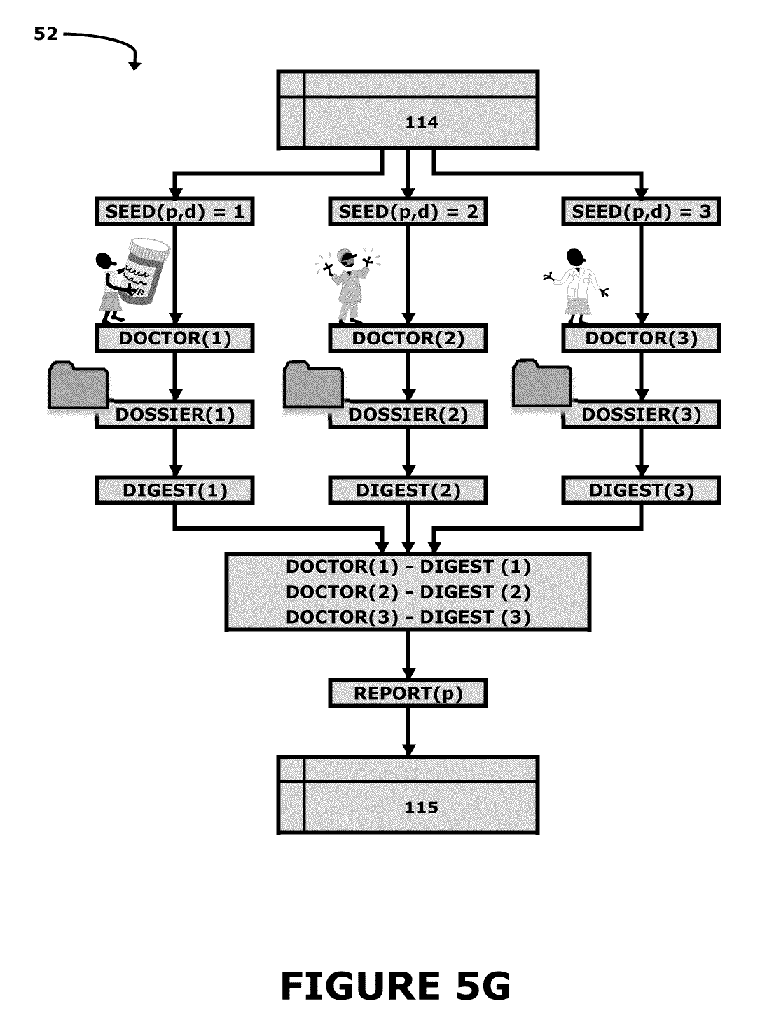

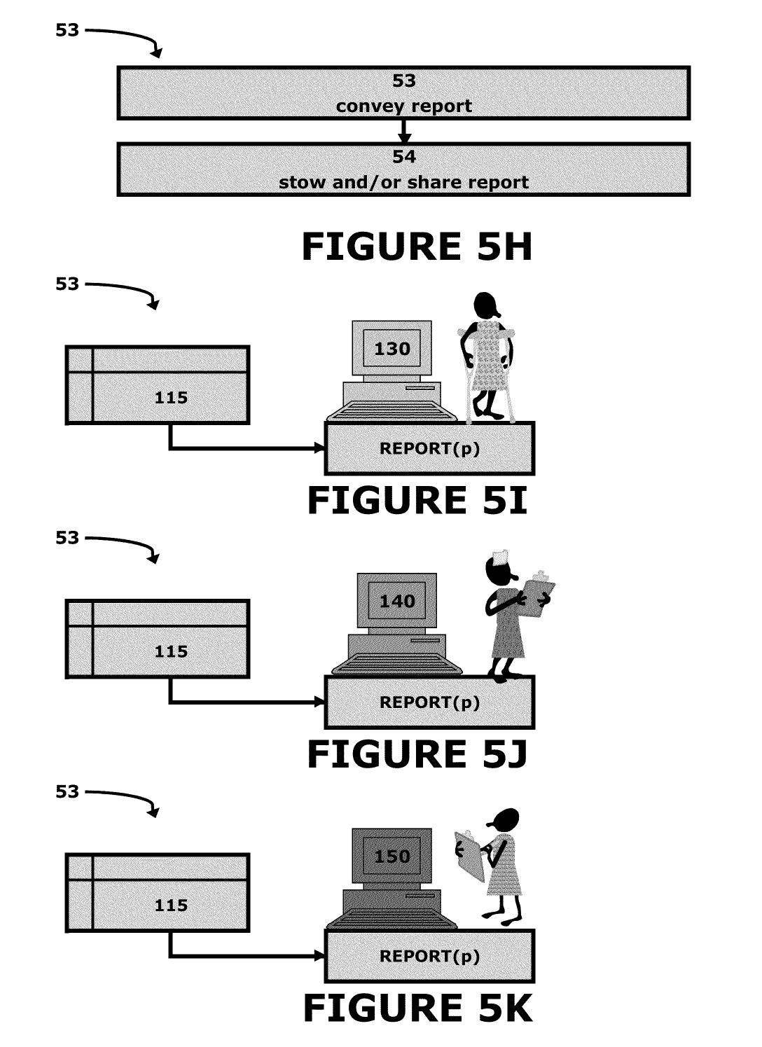

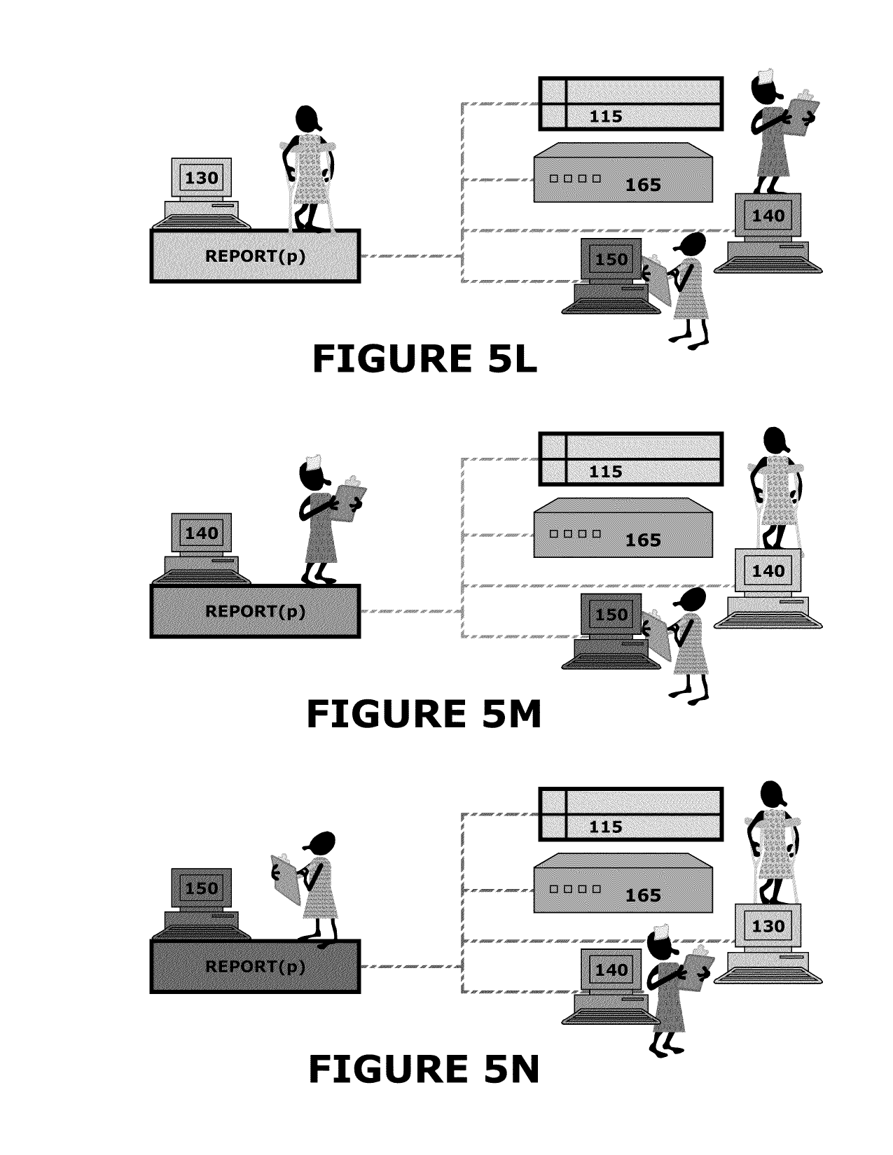

### (FIGS. 5A-5N)

The rank-reporting step 50 reports the outcome of the ranking step 40. This step 50 can comprise a step 51 of triggering a report, a step 52 of preparing a report, and a step 53 of conveying the report. (FIG. 5A.)

The report-triggering step 51 can comprise the server 110 executing the reporting step 50 immediately upon completion of the ranking step 40 without further instructions. (FIG. 5B.) Alternatively, the server 110 can initiate the reporting step 50 when it receives a request from an external site, such as the patient's computer 130, the healthcare organization's computer 140, and/or the insurance carrier's computer 150. (FIGS. 5C-5E.) Other report-triggering techniques may be appropriate and advantageous.

In the report-preparing step 52, the doctors from the top seeded dossiers are assembled into a report. The number of top seeds 110 (e.g., one, two, at least three, etc.) included in the report can be preset by the server 110 and/or determined by a prompted input. Also, a step 52 wherein all of the seeded doctors are included in the report is workable and may be worthwhile.

The report-preparing step 52 can comprise simply listing the names of the top-seeded doctors. (FIG. 5F.) Other information can also be extracted from the corresponding doctor dossiers for inclusion in the summary, such as medical resumes. (FIG. 5G) and/or digests (FIG. 5H).

In the report-conveying step 53, the server 110 can electronically send the report to the computer 130, the computer 140, and/or the computer 150. (FIGS. 5I-5K.) Other patient delivery devices, such as postage mail, telephone voicemail, texts, instant messaging, and/or facsimiles, are conceivable and creatable.

The reporting step 50 can also include a step 54 of selectively stowing and/or sharing all or certain portions of the report. (FIGS. 5K-5L.) For example, report data could be stowed in a storage site 115 on the server 110 and/or in a database 165 located remote from the server 165. Additionally or alternatively, report data could be shared between or among the patient, the healthcare organization, and/or the insurance carrier.

### Roster-Revising Step 60

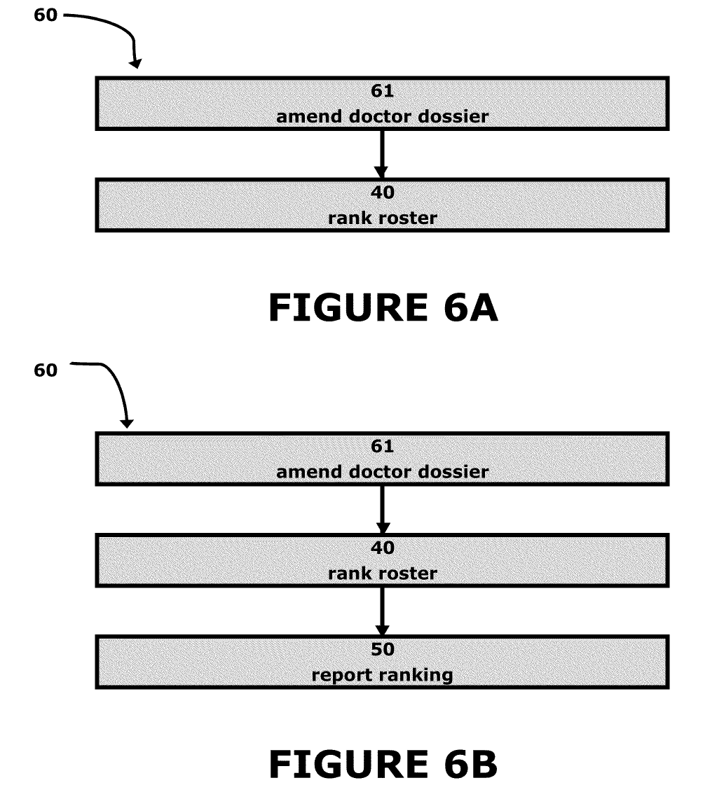

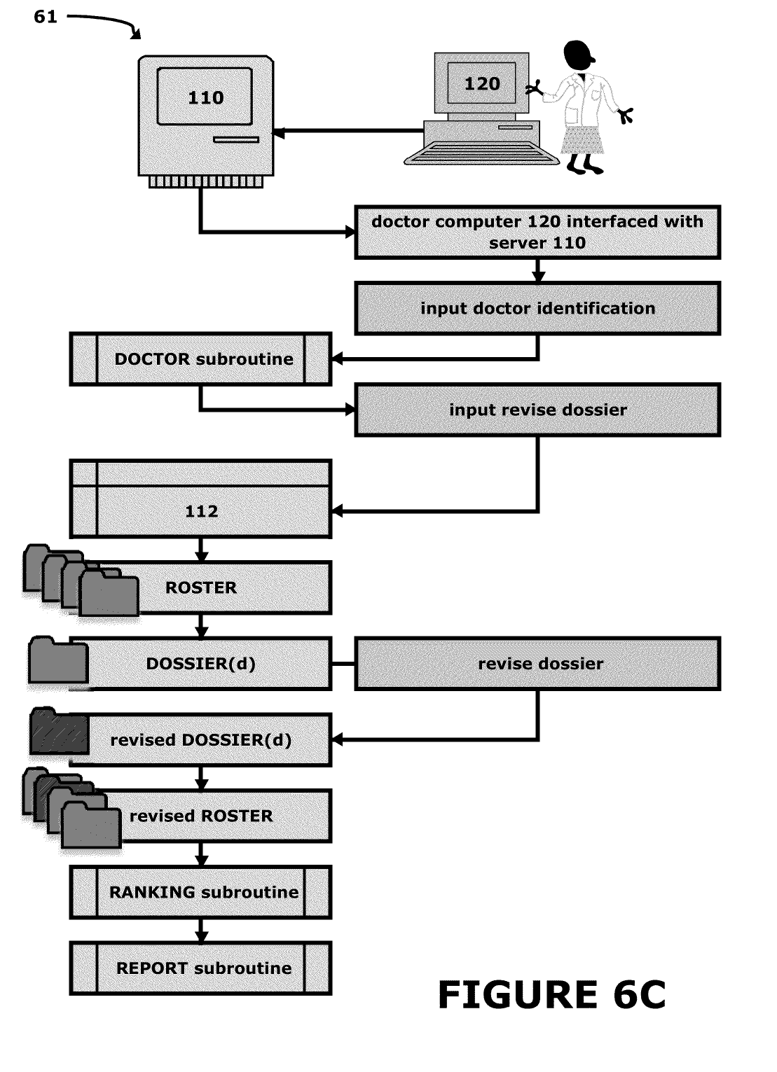

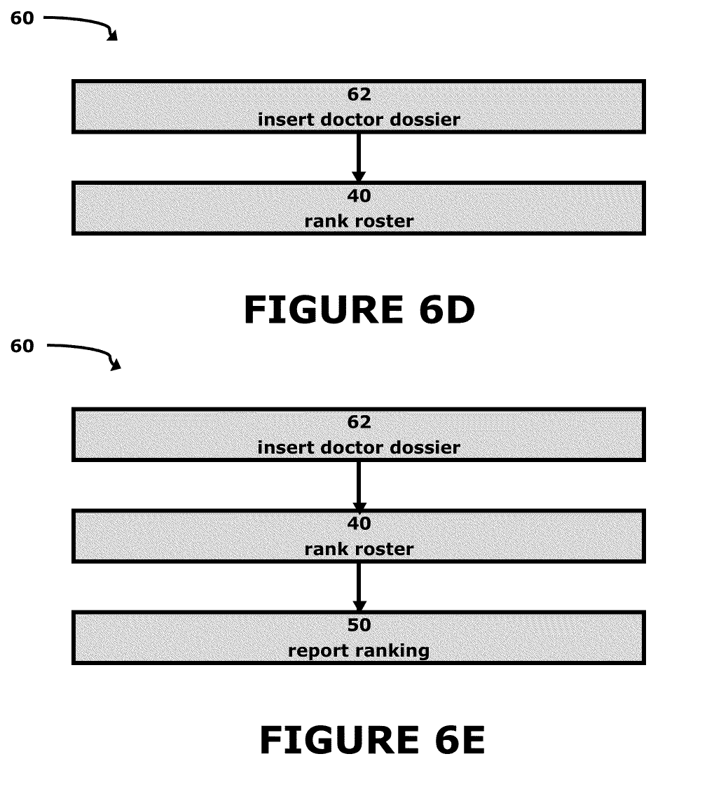

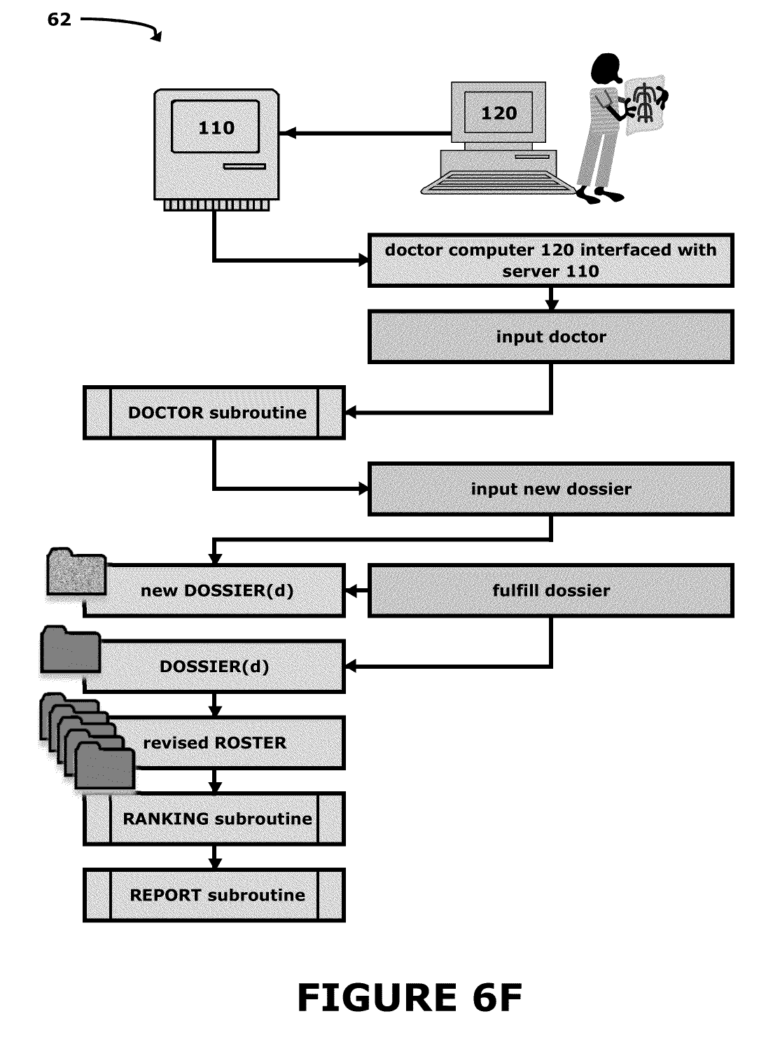

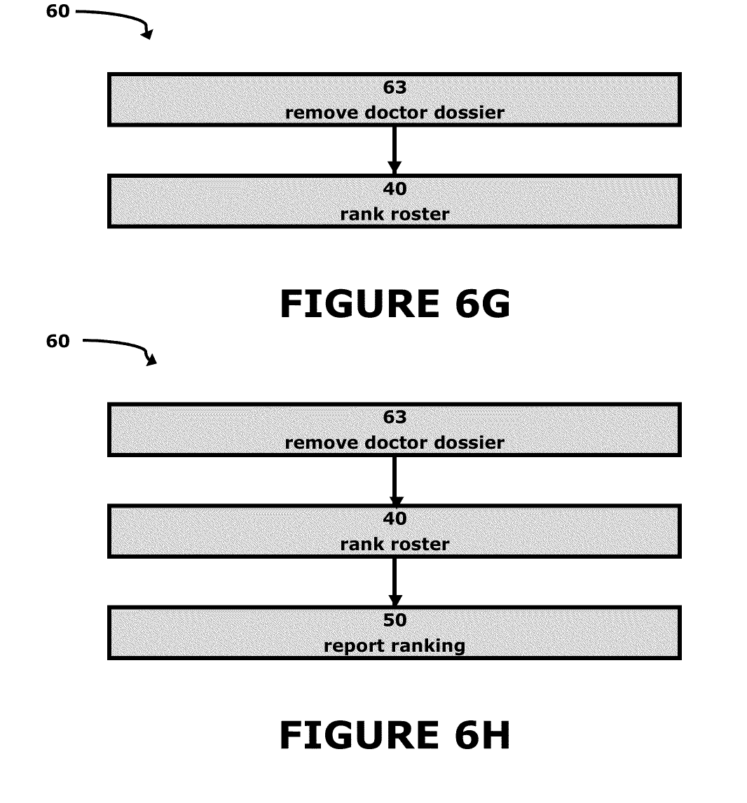

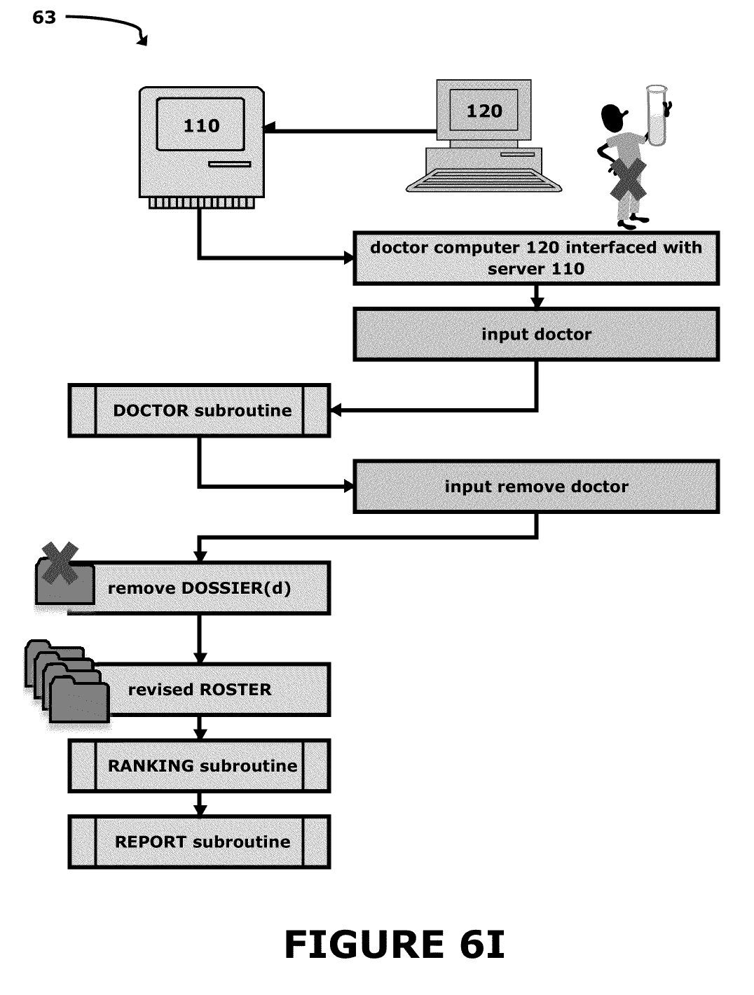

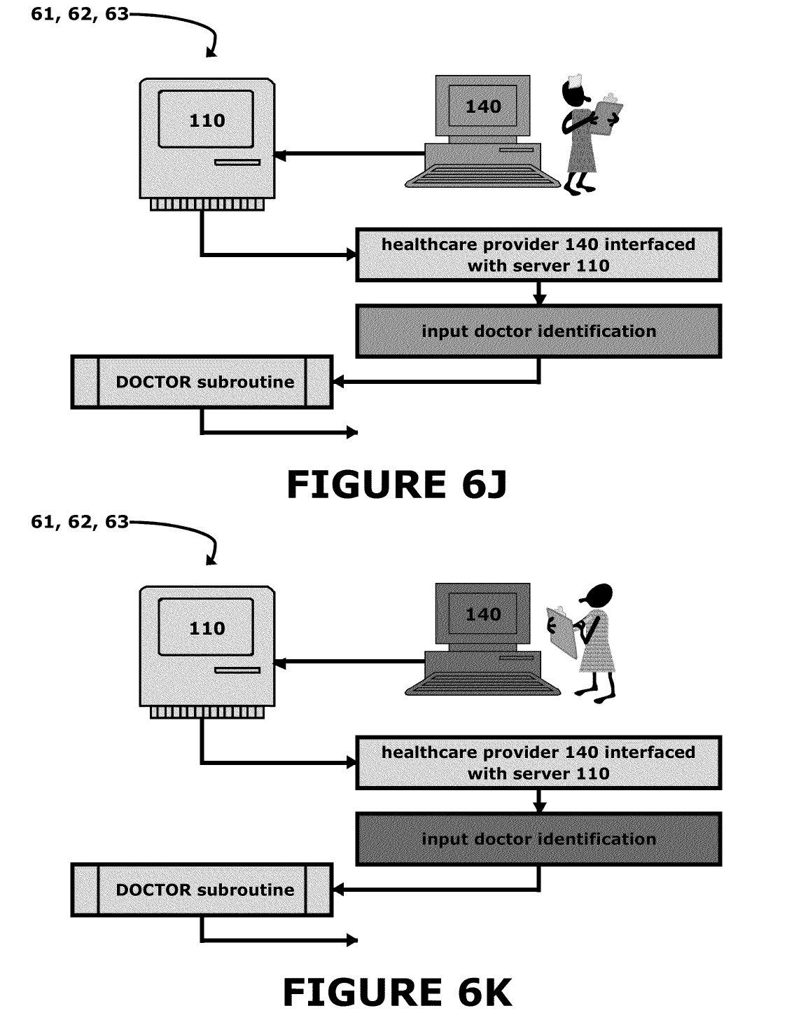

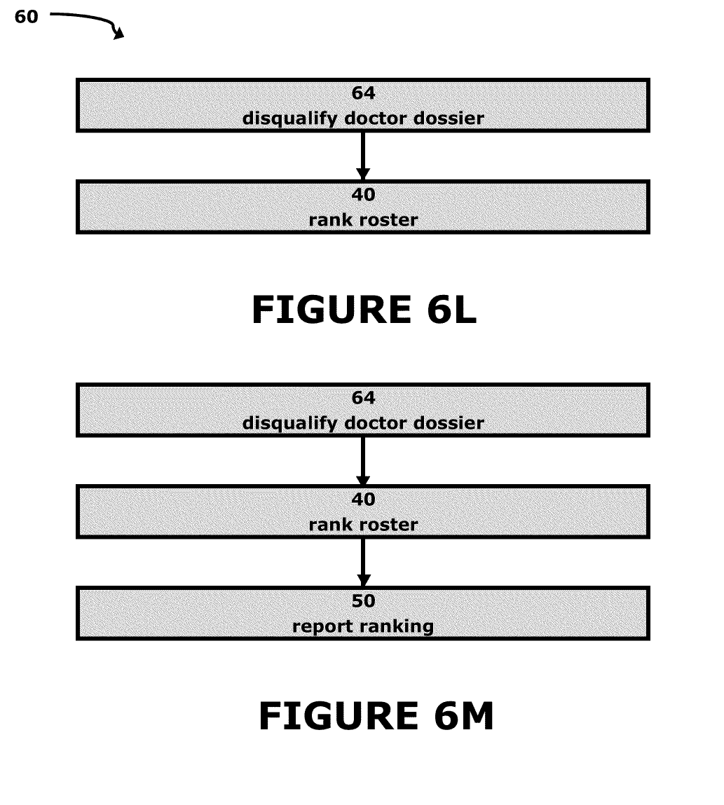

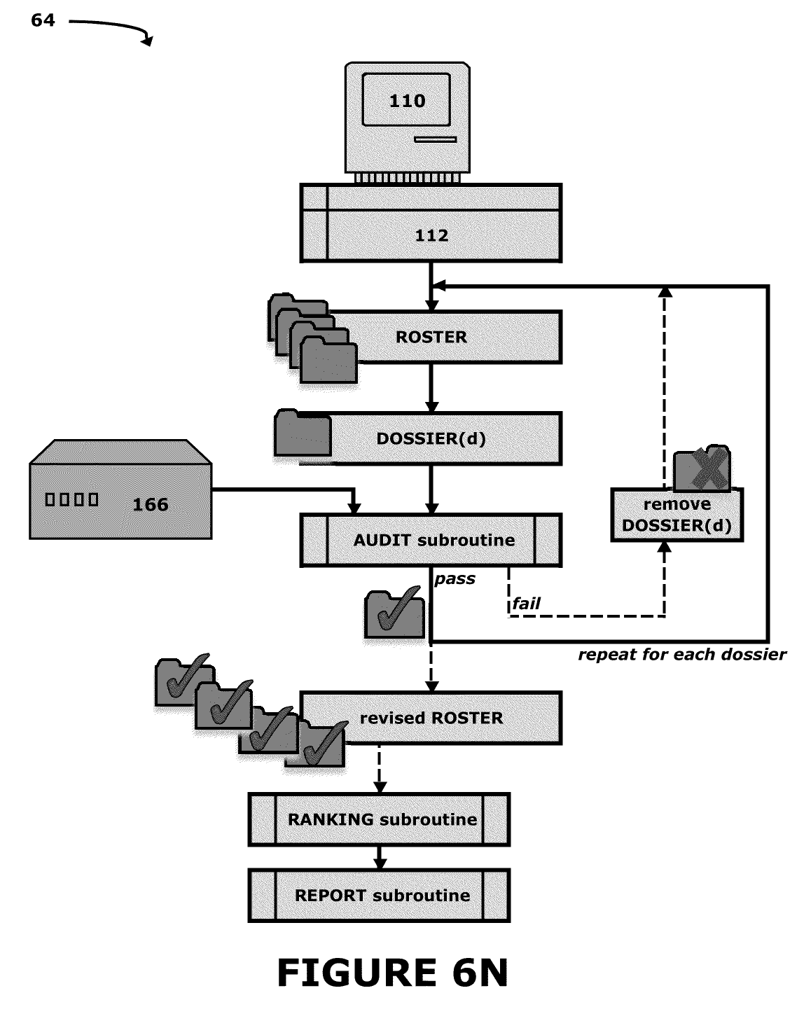

### (FIGS. 6A-6N)

The roster-revising step 60 can comprise a step 61 of amending a doctor dossier already in the roster (FIGS. 6A-6C), a step 62 of inserting another doctor dossier into the roster (FIGS. 6D-6F), and/or a step 63 of removing a doctor dossier from the roster (FIGS. 6G-6I.) The revised roster is then re-ranked via step 40 and this revised ranking can be reported via step 50.

The dossier-amending step 61 could be spawned by, for example, office relocations, insurance coverage changes, and/or certification conferrals. Few edits are expected to be necessary with a doctor's personality predisposition profile (except for perhaps whether they have children or not). That being said, a revision step involving personality-profile edits could be accommodated and may sometimes be advisable.

The dossier-inserting step 62 would be performed, for example, when a new doctor is first awarded his license, is hired by hospital, joins a medical practice, and/or is added to an insurance carrier's preferred provider list.

The dossier-removing step 63 could be inspired by a doctor retiring, relocating out of the roster's geographic reach, or other less fortunate circumstances such as disability or death.

The dossier-amending step 61, the dossier-inserting step 62, and/or the dossier-removing step 63 can be initiated by the doctor (or someone associated therewith) through the computer 120. After the dossier is amended, inserted, or removed, the roster is accordingly revised. The revised roster is then re-ranked via ranking step 40. If this re-ranking overrides an earlier report, this can be remedied by reporting revised results via reporting step 50.

The steps 61-63 can also be initiated by the healthcare organization though its computer 140 and/or the insurance carrier through its computer 150. (FIGS. 6J-6K.)

The roster-revising step 60 can also comprise the step 64 of disqualifying a dossier from the roster. (FIGS. 6L-6N.) This disqualification could be the upshot of an audit run against the roster on a periodic (e.g., daily, weekly, monthly, etc.) basis. If the audit reveals that the doctor has recently had complications with medical licensures and/or disciplinary deviations, he or she can be removed from the roster.

The dossier-disqualifying step 64 is preferably performed without doctor interaction. In this step 64, the roster can be audited against an outside independent database (e.g., one residing on server 166) which monitors doctor licensing and disciplinary matters. The dossier-disqualifying step 64 can be initiated by the server 110 on a periodic basis (e.g., daily, weekly, monthly, etc.) or it can be initiated by the external server 166 when there is a change in its database. In either of any event, a disqualified dossier is removed from the roster to create a revised roster. The revised roster is then re-ranked (via ranking step 40) and the re-ranking is reported if necessary or desired. (FIG. 6L.)

### Portfolio-Updating Step 70

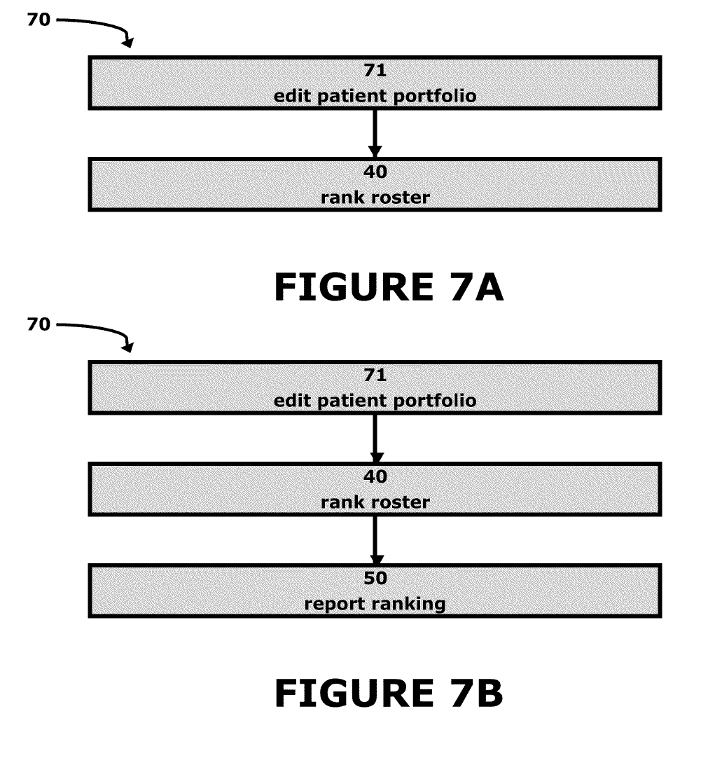

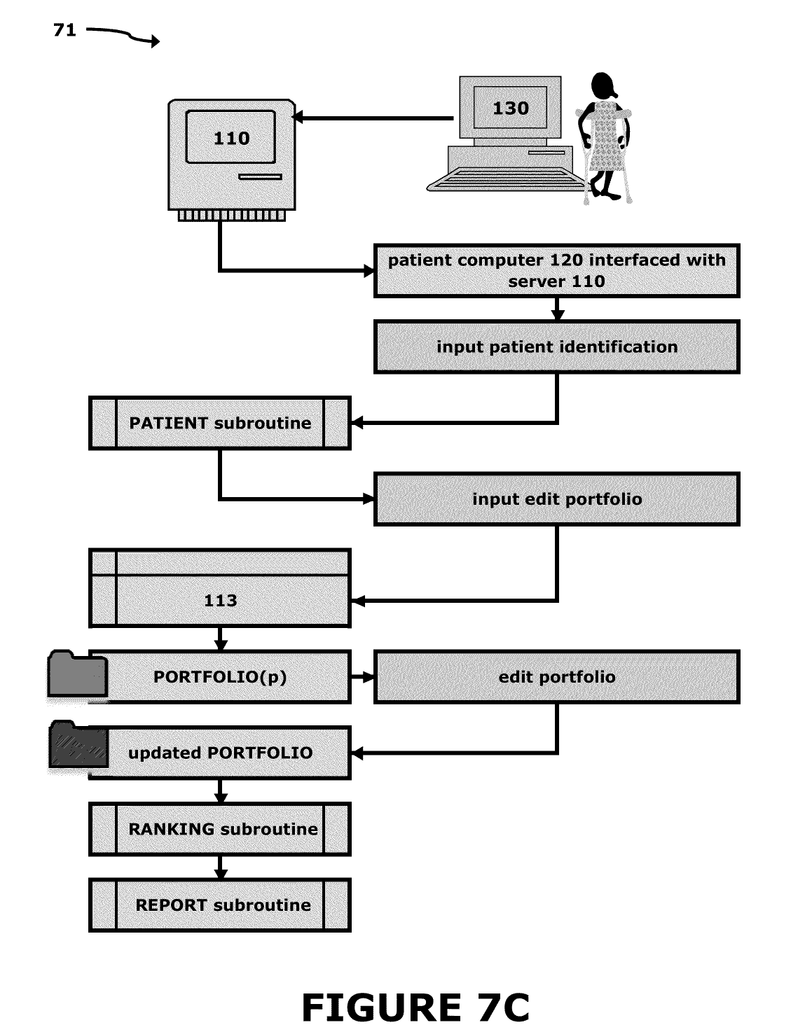

### (FIGS. 7A-7C)

The portfolio-updating step 70 can comprise a step 71 of editing the patient's portfolio. (FIGS. 7A-7B.) The portfolio-editing step 71 could be made necessary by, for example, illness or injury (e.g., requiring a certain specialty), patient relocation, insurance coverage changes, or other factors. While the personality preference profile is expected to remain mostly constant, a step 71 allowing changes to is viable and may be valuable.

The portfolio-editing step 71 can be initiated by the patient (or someone associated therewith) through the computer 113 and edits to the portfolio can also be input therethrough. The server 110 can edit the patient's portfolio accordingly. The roster is then re-ranked, via ranking step 40, against the updated patient portfolio. A revised report can be made if required or requested. (FIG. 7C.)

### CLOSING

Although the system 10, the roster-attaining step 20, the portfolio-obtaining step 30, the roster-ranking step 40, the rank-reporting step 50, the roster-revising step 60, the portfolio-updating step 70, and/or the computer-populated colony 100 have been shown and described with respect to a certain embodiment or embodiments, it is obvious that equivalent alterations and modifications will occur to others skilled in the art upon the reading and understanding of this specification and the annexed drawings.

1. A doctor-selection-facilitating system (10), comprising:
a step (20) of attaining a roster of doctor dossiers, wherein each doctor dossier corresponds to an individual doctor and includes a personality-predisposition profile particular to this doctor,
a step (30) of obtaining a patient portfolio, wherein the patient portfolio corresponds to an individual patient and includes a personality-preference profile particular to this patient, and
a step (40) of ranking the doctor dossiers based on the congruency between the doctors' personality-predisposition profiles and the patient's personality-preference profile;
wherein the steps (20, 30, 40) are performed within a computer-populated colony (100) including a server (110); and
wherein the roster-attaining step (20), the portfolio-obtaining step (30), and the ranking step (40) are performed by the server (110).

2. A doctor-selection-facilitating system (10) as set forth in claim 1, wherein the roster-attaining step (20) comprises obtaining doctor-dossier data from doctor computers (120) interfaced with the server (110) via public network or private network.

3. A doctor-selection-facilitating system (10) as set forth in claim 1, wherein the patient-profile-obtaining step (30) comprises obtaining patient-profile information from a patient computer (130) interfacing with the server (110) via public network or a private network.

4. A doctor-selection-facilitating system (10) as set forth in claim 3, wherein the patient computer (130) interfaces with the server (110) via a public network.

5. A doctor-selection-facilitating system (10) as set forth in claim 3, wherein the patient computer (130) interfaces with the server (110) via a private network.

6. A doctor-selection-facilitating system (10) as set forth in claim 1, wherein the patient-profile-obtaining step (30) comprises obtaining patient-profile information from a healthcare organization computer (140) interfacing with the server (110).

7. A doctor-selection-facilitating system (10) as set forth in claim 6, wherein the healthcare organization computer (140) interfaces with the server (110) via a private virtual network.

8. A doctor-selection-facilitating system (10) as set forth in claim 1, wherein the patient-profile-obtaining step (30) comprises obtaining patient-profile information from an insurance carrier computer (150) interfacing with the server (110).

9. A doctor-selection-facilitating system (10) as set forth in claim 9, wherein the insurance carrier computer (150) interfaces with the server (110) via a private virtual network.

10. A doctor-selection-facilitating system (10) as set forth in claim 1, further comprising a step (50) of reporting results of the ranking step (40).

11. A doctor-selection-facilitating system (10) as set forth in claim 10, wherein the results-reporting step (50) comprises reporting the ranking results to a patient computer (130) interfaced with the server (110) via a public network or a private network.

12. A doctor-selection-facilitating system (10) as set forth in claim 10, wherein the results-reporting step (50) comprises reporting the ranking results to a healthcare organization computer (140) interfaced with the server (110) via a private virtual network.

13. A doctor-selection-facilitating system (10) as set forth in claim 10, wherein the results-reporting step (50) comprises reporting the ranking results to an insurance carrier computer (150) interfaced with the server (110) via a private virtual network.

14. A doctor-selection-facilitating system (10) as set forth in claim 1, wherein the personality-predisposition profile of each doctor dossier includes information pertaining to the doctor's predisposed personality traits and wherein the personality-preference profile of the patient portfolio includes information pertaining to the patient's preferred personality traits for a doctor;

15. A doctor-selection-facilitating system (10) as set forth in claim 14, wherein the information within the personality-predisposition profile of each doctor dossier is not importance scored, and wherein the information within the personality-preference profile of the patient portfolio is importance scored.

16. A doctor-selection-facilitating system (10) as set forth in claim 1, further comprising a step (60) of revising the roster, and wherein the roster-ranking step (40) is repeated after the roster-revising step (60).

17. A doctor-selection-facilitating system (10) as set forth in claim 16, wherein the roster-revising step (40) comprises amending a doctor dossier already in the roster, inserting a new doctor dossier into the roster, and/or removing a doctor dossier from the roster.

18. A doctor-selection-facilitating system (10) as set forth in claim 16, wherein the roster-revising step (60) comprises disqualifying a dossier from the roster based on an external database.

19. A doctor-selection-facilitating system (10) as set forth in claim 1, further comprising a step (70) of updating the patient portfolio, and wherein the roster-ranking step (40) is repeated after the portfolio-updating step (70).

20. A computer server (110) configured to perform the roster-attaining step (20), the portfolio-obtaining step (30), and the ranking step (40) set forth in claim 1.
